(19) United States
(12) Patent Application Publication
(10) Pub. No.: US 2024/0267959 A1
(43) Pub. Date: Aug. 8, 2024

(54) METHOD AND APPARATUS FOR APPLICATION LAYER MEASUREMENT REPORTING IN UNLICENSED SPECTRUM

(71) Applicant: SAMSUNG ELECTRONICS CO., LTD., Suwon-si (KR)

(72) Inventors: Anil AGIWAL, Suwon-si (KR); Jaehyuk JANG, Suwon-si (KR); Seungbeom JEONG, Suwon-si (KR)

(21) Appl. No.: 18/431,903

(22) Filed: Feb. 2, 2024

(30) Foreign Application Priority Data
Feb. 2, 2023 (KR) 10-2023-0014158

(51) Int. Cl. H04W 74/08; H04W 8/22

(52) U.S. Cl. CPC H04W 74/0875; H04W 8/22

(57) ABSTRACT

The disclosure relates to a 5G or 6G communication system for supporting a higher data transmission rate. A method performed by a user equipment (UE) in a wireless communication system is provided. The method includes receiving, from a base station, configuration information for an application layer measurement reporting; generating, based on the configuration information, a medium access control (MAC) protocol data unit (PDU) including a MAC service data unit (SDU) for an application layer measurement report message; in case that an uplink (UL) grant for the MAC PDU is associated with a shared spectrum, determining a channel access priority class (CAPC) of the MAC PDU based on a CAPC for a logical channel (LCH) of signaling radio bearer 4 (SRB4); and transmitting, to the base station, the MAC PDU after a channel access procedure based on the CAPC of the MAC PDU.

### CROSS-REFERENCE TO RELATED APPLICATIONS

This application is based on and claims priority under 35 U.S.C. § 119 to Korean Patent Application No. 10-2023-0014158 filed on Feb. 2, 2023, in the Korean Intellectual Property Office, the disclosure of which is incorporated by reference herein in its entirety.

### BACKGROUND

### 1. Field

The present disclosure relates to a wireless communication system. Specifically, the disclosure relates to an apparatus, a method and a system for application layer measurement reporting in unlicensed spectrum.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIOT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

With the advancement of wireless communication technology, application layer measurement reporting in licensed spectrum has been introduced. A user equipment (UE) capable of application layer measurement reporting in an RRC_CONNECTED state may initiate the procedure when configured with application layer measurement. However, the functionality of application layer measurement reporting is currently not supported in the context of new radio-unlicensed (NR-U) system. Accordingly, aspects of the disclosure are to address at least the above-mentioned problems and/or disadvantages.

In accordance with an aspect of the disclosure, a method performed by a user equipment (UE) in a wireless communication system is provided. The method includes receiving, from a base station, configuration information for an application layer measurement reporting; generating, based on the configuration information, a medium access control (MAC) protocol data unit (PDU) including a MAC service data unit (SDU) for an application layer measurement report message; in case that an uplink (UL) grant for the MAC PDU is associated with a shared spectrum, determining a channel access priority class (CAPC) of the MAC PDU based on a CAPC for a logical channel (LCH) of signaling radio bearer 4 (SRB4); and transmitting, to the base station, the MAC PDU after a channel access procedure based on the CAPC of the MAC PDU.

In accordance with another aspect of the disclosure, a method performed by a base station in a wireless communication system is provided. The method includes transmitting, to a UE, configuration information for an application layer measurement reporting; and receiving, from the UE, a MAC PDU including a MAC SDU for an application layer measurement report message generated based on the configuration information. In case that a UL grant for the MAC PDU is associated with a shared spectrum, a CAPC of the MAC PDU is associated with a CAPC for a LCH of SRB4.

In accordance with another aspect of the disclosure, a UE in a wireless communication system is provided. The UE includes a transceiver and a controller operably coupled to the transceiver. The controller is configured to receive, from a base station via the transceiver, configuration information for an application layer measurement reporting, generate, based on the configuration information, a MAC PDU including a MAC SDU for an application layer measurement report message, in case that a UL grant for the MAC PDU is associated with a shared spectrum, determine a CAPC of the MAC PDU based on a CAPC for a LCH of SRB4, and transmit, to the base station via the transceiver, the MAC PDU after a channel access procedure based on the CAPC of the MAC PDU.

In accordance with another aspect of the disclosure, a base station in a wireless communication system is provided. The base station includes a transceiver and a controller operably coupled to the transceiver. The controller is configured to transmit, to a UE via the transceiver, configuration information for an application layer measurement reporting, and receive, from the UE via the transceiver, a MAC PDU including a MAC SDU for an application layer measurement report message generated based on the configuration information. In case that a UL grant for the MAC PDU is associated with a shared spectrum, a CAPC of the MAC PDU is associated with a CAPC for a LCH of SRB4.

According to various embodiments of the disclosure, application layer measurement reporting is enabled in unlicensed/shared spectrum and the network can efficiently collect user's quality of experiences (QoE).

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a signaling flow between a UE and a gNB for application layer measurement reporting according to an embodiment of the present disclosure;

FIG. 2 illustrates a signaling flow between a UE and a gNB for application layer measurement reporting according to an embodiment of the present disclosure;

FIGS. 3A and 3B illustrate signaling flows between a UE and a gNB for application layer measurement reporting according to an embodiment of the present disclosure;

FIGS. 4A and 4B illustrate signaling flows between a UE and a gNB for application layer measurement reporting according to an embodiment of the present disclosure;

FIGS. 5A and 5B illustrate signaling flows between a UE and a gNB for application layer measurement reporting according to an embodiment of the present disclosure;

FIGS. 6A and 6B illustrate signaling flows between a UE and a gNB for application layer measurement reporting according to an embodiment of the present disclosure;

FIG. 7 illustrates a signaling flow between a UE and a gNB for application layer measurement reporting according to an embodiment of the present disclosure;

FIG. 8 illustrates a signaling flow between a UE and a gNB for application layer measurement reporting according to an embodiment of the present disclosure;

FIGS. 9A and 9B illustrate signaling flows between a UE and a gNB for application layer measurement reporting according to an embodiment of the present disclosure;

FIGS. 10A and 10B illustrate signaling flows between a UE and a gNB for application layer measurement reporting according to an embodiment of the present disclosure;

FIG. 11 illustrates an electronic device according to embodiments of the present disclosure; and

FIG. 12 illustrates a base station according to embodiments of the present disclosure.

Throughout the drawings, like reference numerals will be understood to refer to like parts, components, and structures.

### DETAILED DESCRIPTION

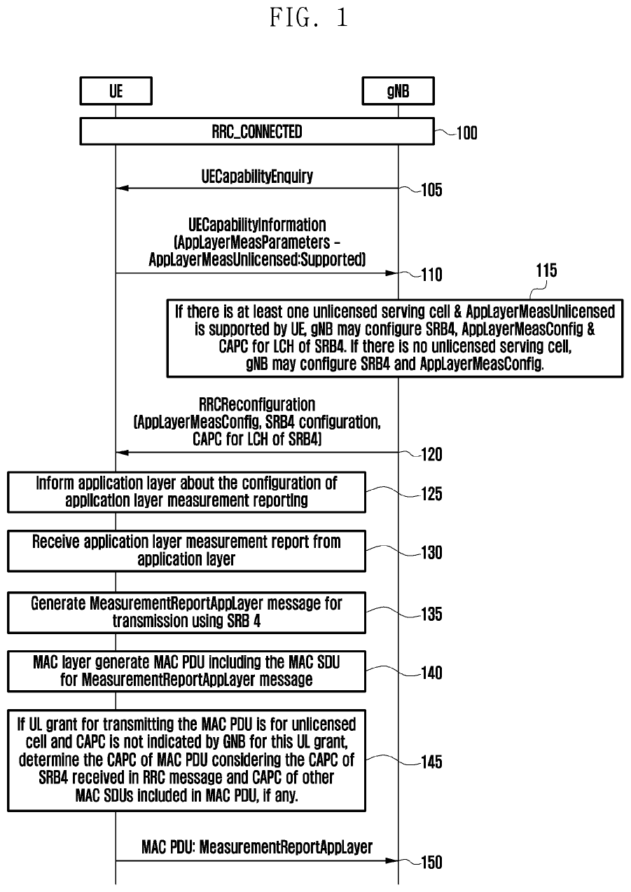

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

In this description, the words “unit,” “module” or the like may refer to a software component or hardware component, such as, for example, a field-programmable gate array (FPGA) or an application-specific integrated circuit (ASIC) capable of carrying out a function or an operation. However, a “unit,” or the like, is not limited to hardware or software. A unit, or the like, may be configured so as to reside in an addressable storage medium or to drive one or more processors. Units, or the like, may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

Prior to the detailed description, terms or definitions necessary to understand the disclosure are described. However, these terms should be construed in a non-limiting way.

The “base station (BS)” is an entity communicating with a user equipment (UE) and may be referred to as BS, base transceiver station (BTS), node B (NB), evolved NB (eNB), access point (AP), 5G NB (5 GNB), or gNB.

The “UE” is an entity communicating with a BS and may be referred to as a UE, a device, a mobile station (MS), a mobile equipment (ME), or a terminal.

In the recent years, several broadband wireless technologies have been developed to meet the growing number of broadband subscribers and to provide more and better applications and services. The second-generation wireless communication system has been developed to provide voice services while ensuring the mobility of users. Third generation wireless communication system supports not only the voice service but also data service. In recent years, the fourth wireless communication system has been developed to provide high-speed data service. However, currently, the fourth generation wireless communication system suffers from lack of resources to meet the growing demand for high speed data services. So fifth generation wireless communication system (also referred as next generation radio or NR) is being developed to meet the growing demand for high speed data services, support ultra-reliability and low latency applications.

The fifth generation wireless communication system supports not only lower frequency bands but also in higher frequency (mmWave) bands, e.g., 10 GHz to 100 GHz bands, so as to accomplish higher data rates. To mitigate propagation loss of the radio waves and increase the transmission distance, the beamforming, massive Multiple-Input Multiple-Output (MIMO), Full Dimensional MIMO (FD-MIMO), array antenna, an analog beam forming, large scale antenna techniques are being considered in the design of fifth generation wireless communication system. In addition, the fifth generation wireless communication system is expected to address different use cases having quite different requirements in terms of data rate, latency, reliability, mobility etc. However, it is expected that the design of the air-interface of the fifth generation wireless communication system would be flexible enough to serve the UEs having quite different capabilities depending on the use case and market segment the UE cater service to the end customer. Few example use cases the fifth generation wireless communication system wireless system is expected to address is enhanced Mobile Broadband (eMBB), massive Machine Type Communication (m-MTC), ultra-reliable low latency communication (URLLC) etc. The eMBB requirements like tens of Gbps data rate, low latency, high mobility so on and so forth address the market segment representing the conventional wireless broadband subscribers needing internet connectivity everywhere, all the time and on the go. The m-MTC requirements like very high connection density, infrequent data transmission, very long battery life, low mobility address so on and so forth address the market segment representing the Internet of Things (IoT)/Internet of Everything (IoE) envisioning connectivity of billions of devices. The URLLC requirements like very low latency, very high reliability and variable mobility so on and so forth address the market segment representing the Industrial automation application, vehicle-to-vehicle/vehicle-to-infrastructure communication foreseen as one of the enabler for autonomous cars.

In the fifth generation wireless communication system operating in higher frequency (mmWave) bands, a UE and a gNB communicates with each other using Beamforming. Beamforming techniques are used to mitigate the propagation path losses and to increase the propagation distance for communication at higher frequency band. Beamforming enhances the transmission and reception performance using a high-gain antenna. Beamforming can be classified into Transmission (TX) beamforming performed in a transmitting end and reception (RX) beamforming performed in a receiving end. In general, the TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of the TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming technique, a transmitter can make plurality of transmit beam patterns of different directions. Each of these transmit beam patterns can be also referred as transmit (TX) beam. Wireless communication system operating at high frequency uses plurality of narrow TX beams to transmit signals in the cell as each narrow TX beam provides coverage to a part of cell. The narrower the TX beam, higher is the antenna gain and hence the larger the propagation distance of signal transmitted using beamforming. A receiver can also make plurality of receive (RX) beam patterns of different directions. Each of these receive patterns can be also referred as receive (RX) beam.

The fifth generation wireless communication system, supports standalone mode of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in the RRC_CONNECTED state not configured with CA/DC there is only one serving cell comprising of the primary cell.

For a UE in the RRC_CONNECTED state configured with CA/DC the term “serving cells” is used to denote the set of cells comprising of the Special Cell(s) and all secondary cells. In NR the term master cell group (MCG) refers to a group of serving cells associated with the master node, comprising of the PCell and optionally one or more SCells. In NR the term secondary cell group (SCG) refers to a group of serving cells associated with the Secondary Node, comprising of the PSCell and optionally one or more SCells. In NR PCell (primary cell) refers to a serving cell in MCG, operating on the primary frequency, in which the UE either performs the initial connection establishment procedure or initiates the connection re-establishment procedure. In NR for a UE configured with CA, Scell is a cell providing additional radio resources on top of Special Cell. Primary SCG Cell (PSCell) refers to a serving cell in SCG in which the UE performs random access when performing the reconfiguration with sync procedure. For Dual Connectivity operation the term SpCell (i.e., Special Cell) refers to the PCell of the MCG or the PSCell of the SCG, otherwise the term special cell refers to the PCell.

System information acquisition in fifth generation wireless communication system: In the fifth generation wireless communication system, node B (gNB) or base station in cell broadcast Synchronization Signal and PBCH block (SSB) consists of primary and secondary synchronization signals (PSS, SSS) and system information. System information includes common parameters needed to communicate in cell. In the fifth generation wireless communication system (also referred as next generation radio or NR), System Information (SI) is divided into the MIB and a number of SIBs where:
the MIB is always transmitted on the BCH with a periodicity of 80 ms and repetitions made within 80 ms and it includes parameters that are needed to acquire SIB1 from the cell;
the SIB1 is transmitted on the DL-SCH with a periodicity of 160 ms and variable transmission repetition. The default transmission repetition periodicity of SIB1 is 20 ms but the actual transmission repetition periodicity is up to network implementation. The scheduling information in SIB1 includes mapping between SIBs and SI messages, periodicity of each SI message and SI window length. The scheduling information in SIB1 includes an indicator for each SI message, which indicates whether the concerned SI message is being broadcasted or not. If at least one SI message is not being broadcasted, SIB1 may include random access resources (PRACH preamble(s) and PRACH resource(s)) for requesting gNB to broadcast one or more SI message(s); and
SIBs other than SIB1 are carried in SystemInformation (SI) messages, which are transmitted on the DL-SCH. Only SIBs having the same periodicity can be mapped to the same SI message. Each SI message is transmitted within periodically occurring time domain windows (referred to as SI-windows with same length for all SI messages). Each SI message is associated with a SI-window and the SI-windows of different SI messages do not overlap. That is, within one SI-window only the corresponding SI message is transmitted. Any SIB except SIB1 can be configured to be cell specific or area specific, using an indication in SIB1. The cell specific SIB is applicable only within a cell that provides the SIB while the area specific SIB is applicable within an area referred to as SI area, which consists of one or several cells and is identified by system InformationAreaID.

PDCCH in fifth generation wireless communication system: In the fifth generation wireless communication system, physical downlink control channel (PDCCH) is used to schedule DL transmissions on PDSCH and UL transmissions on PUSCH, where the downlink control information (DCI) on PDCCH includes: Downlink assignments containing at least modulation and coding format, resource allocation, and hybrid-ARQ information related to DL-SCH; Uplink scheduling grants containing at least modulation and coding format, resource allocation, and hybrid-ARQ information related to UL-SCH. In addition to scheduling, PDCCH can be used to for: Activation and deactivation of configured PUSCH transmission with configured grant;
activation and deactivation of PDSCH semi-persistent transmission; Notifying one or more UEs of the slot format; notifying one or more UEs of the PRB(s) and OFDM symbol(s) where the UE may assume no transmission is intended for the UE; Transmission of TPC commands for PUCCH and PUSCH; transmission of one or more TPC commands for SRS transmissions by one or more UEs; Switching a UE's active bandwidth part; Initiating a random access procedure.

A UE monitors a set of PDCCH candidates in the configured monitoring occasions in one or more configured control resource sets (CORESETs) according to the corresponding search space configurations. A CORESET consists of a set of PRBs with a time duration of 1 to 3 OFDM symbols. The resource units resource element groups (REGs) and control channel elements (CCEs) are defined within a CORESET with each CCE comprising a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own DMRS. QPSK modulation is used for PDCCH.

In fifth generation wireless communication system, a list of search space configurations is signaled by a gNB for each configured BWP wherein each search configuration is uniquely identified by an identifier. Identifier of search space configuration to be used for specific purpose such as paging reception, SI reception, random access response reception is explicitly signaled by a gNB. In NR search space configuration comprises of parameters Monitoring-periodicity-PDCCH-slot, Monitoring-offset-PDCCH-slot, Monitoring-symbols-PDCCH-within-slot and duration. A UE determines PDCCH monitoring occasion (s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots “x” to x+duration where the slot with number “x” in a radio frame with number “y” satisfies the equation below:

(y*(number of slots in a radio frame)+x−Monitoring-offset-PDCCH-slot) mod (Monitoring-periodicity-PDCCH-slot)=0.

The starting symbol of a PDCCH monitoring occasion in each slot having PDCCH monitoring occasion is given by Monitoring-symbols-PDCCH-within-slot. The length (in symbols) of a PDCCH monitoring occasion is given in the corset associated with the search space. search space configuration includes the identifier of coreset configuration associated with it. A list of coreset configurations is signaled by a gNB for each configured BWP wherein each coreset configuration is uniquely identified by an identifier. Note that each radio frame is of 10 ms duration. Radio frame is identified by a radio frame number or system frame number. Each radio frame comprises of several slots wherein the number of slots in a radio frame and duration of slots depends on sub carrier spacing. The number of slots in a radio frame and duration of slots depend on a radio frame for each supported SCS is pre-defined in NR. Each coreset configuration is associated with a list of TCI (Transmission configuration indicator) states.

One DL RS ID (SSB or CSI RS) is configured per TCI state. The list of TCI states corresponding to a coreset configuration is signaled by a gNB via RRC signaling. One of the TCI state in TCI state list is activated and indicated to a UE by a gNB via MAC CE. TCI state indicates the DL TX beam (DL TX beam is QCLed with SSB/CSI RS of TCI state) used by a gNB for transmission of PDCCH in the PDCCH monitoring occasions of a search space. For PDSCH, TCI state of scheduling PDCCH can be used for scheduled PDSCH. Alternately, TCI state of the PDCCH for the lowest corset ID in the slot is used for PDSCH. Alternately combination of RRC+MAC CE+DCI is used to indicate the TCI state for PDSCH. RRC configures a list of TCI state, MAC CE indicates a subset of these TCI states and DCI indicates one of the TCI state from list of TCI states indicated in MAC CE.

Bandwidth adaptation in fifth generation wireless communication system: In fifth generation wireless communication system bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a bandwidth part (BWP). BA is achieved by configuring RRC connected UE with BWP(s) and telling the UE which of the configured BWPs is currently the active one. When BA is configured, the UE only has to monitor PDCCH on the one active BWP i.e., it does not have to monitor PDCCH on the entire DL frequency of the serving cell.

In an RRC connected state, a UE is configured with one or more DL and UL BWPs, for each configured Serving Cell (i.e., PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwp-Inactivity Timer, by RRC signaling, or by the MAC entity itself upon initiation of random access procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

Random access in fifth generation wireless communication system: In the 5G wireless communication system, random access (RA) is supported. Random access (RA) is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UE in an RRC_CONNECTED state. Several types (2 step or 4 step contention based random access, contention free random access, etc.) random access procedure is supported.

Paging in fifth generation wireless communication system: In the 5th generation (also referred as NR or New Radio) wireless communication system UE can be in one of the following RRC state: RRC IDLE, RRC INACTIVE and RRC CONNECTED. The RRC states can further be characterized as follows:
In an RRC_IDLE state, a UE specific DRX may be configured by upper layers (i.e., NAS). The UE monitors short messages transmitted with P-RNTI over DCI; monitors a paging channel for CN paging using 5G-S-TMSI; —performs neighbouring cell measurements and cell (re-)selection; Acquires system information and can send SI request (if configured).
In an RRC_INACTIVE state, a UE specific DRX may be configured by upper layers or by RRC layer; In this state, the UE stores the UE Inactive AS context. A RAN-based notification area is configured by RRC layer. The UE monitors Short Messages transmitted with P-RNTI over DCI; Monitors a Paging channel for CN paging using 5G-S-TMSI and RAN paging using fullI-RNTI; Performs neighbouring cell measurements and cell (re-)selection; Performs RAN-based notification area updates periodically and when moving outside the configured RAN-based notification area; Acquires system information and can send SI request (if configured).
In an RRC_CONNECTED state, the UE stores the AS context. Unicast data is transmitted/received to/from the UE. At lower layers, the UE may be configured with a UE specific DRX. The UE monitors Short Messages transmitted with P-RNTI over DCI, if configured; monitors control channels associated with the shared data channel to determine if data is scheduled for it; Provides channel quality and feedback information; performs neighbouring cell measurements and measurement reporting; and acquires system information.

The 5G or Next Generation radio access network (NG-RAN) based on NR consists of NG-RAN nodes where NG-RAN node is a gNB, providing NR user plane and control plane protocol terminations towards the UE. The gNBs are also connected by means of the NG interfaces to the 5GC, more specifically to the access and mobility management function (AMF) by means of the NG-C interface and to the user plane function (UPF) by means of the NG-U interface. In the 5th generation (also referred as NR or New Radio) wireless communication system, the UE may use discontinuous reception (DRX) in an RRC_IDLE and an RRC_INACTIVE states in order to reduce power consumption. In the RRC_IDLE/RRC_INACTIVE state, a UE wakes up at regular intervals (i.e., every DRX cycle) for short periods to receive paging, to receive SI update notification and to receive emergency notifications.

A paging message is transmitted using physical downlink shared channel (PDSCH). Physical downlink common control channel (PDCCH) is addressed to P-RNTI if there is a paging message in PDSCH. P-RNTI is common for all UEs. UE identity (i.e., S-TMSI for an RRC_IDLE UE or I-RNTI for an RRC_INACTIVE state UE) is included in the paging message to indicate paging for a specific UE. A paging message may include multiple UE identities to page multiple UEs. A paging message is broadcasted (i.e., PDCCH is masked with P-RNTI) over data channel (i.e., PDSCH). SI update and emergency notifications are included in DCI and PDCCH carrying this DCI is addressed to P-RNTI. In the RRC idle/inactive mode UE monitors one paging occasion (PO) every DRX cycle. In the RRC idle/inactive mode, a UE monitors PO in initial DL BWP. In RRC connected state UE monitors one or more POs to receive SI update notification and to receive emergency notifications. In RRC connected state, the UE can monitor any PO in paging DRX cycle and monitors at least one PO in SI modification period. In the RRC idle/inactive mode, the UE monitors PO every DRX cycle in its active DL BWP. A PO is a set of “S” PDCCH monitoring occasions for paging, where “S” is the number of transmitted SSBs (i.e., the Synchronization Signal and PBCH block (SSB) consists of primary and secondary synchronization signals (PSS, SSS) and PBCH) in cell. The UE first determines the paging frame (PF) and then determines the PO with respect to the determined PF. One PF is a radio frame (10 ms).
The PF for a UE is the radio frame with system frame number “SFN” which satisfies the equation (SFN+PF_offset) mod T=(T div N)*(UE_ID mod N).
Index (i_s), indicating the index of the PO is determined by i_s=floor (UE_ID/N) mod Ns.
Tis DRX cycle of the UE.
In an RRC_INACTIVE state, T is determined by the shortest of the UE specific DRX value configured by RRC, a UE specific DRX value configured by NAS, and a default DRX value broadcast in system information.
In an RRC_IDLE state, T is determined by the shortest of UE specific DRX value configured by NAS, and a default DRX value broadcast in system information. If a UE specific DRX is not configured by upper layers (i.e., NAS), the default value is applied:
N: number of total paging frames in T;
Ns: number of paging occasions for a PF;
PF_offset: offset used for PF determination;
UE_ID: 5G-S-TMSI mod 1024;
Parameters Ns, nAndPagingFrameOffset, and the length of default DRX Cycle are signaled in SIB1. The values of N and PF_offset are derived from the parameter nAndPagingFrame Offset as defined in TS 38.331. If the UE has no 5G-S-TMSI, for instance when the UE has not yet registered onto the network, the UE may use as default identity UE_ID=0 in the PF and i_s formulas above;
The PDCCH monitoring occasions for paging are determined based on paging search space configuration (paging-SearchSpace) signaled by a gNB;
When SearchSpaceId=0 is configured for pagingSearchSpace, the PDCCH monitoring occasions for paging are same as for RMSI as defined in clause 13 in TS 38.213. When SearchSpaceId=0 is configured for pagingSearchSpace, Ns is either 1 or 2. For Ns=1, there is only one PO which starts from the first PDCCH monitoring occasion for paging in the PF. For Ns=2, PO is either in the first half frame (i_s=0) or the second half frame (i_s=1) of the PF; and/or
When SearchSpaceId other than 0 is configured for pagingSearchSpace, the UE monitors the (i_s+1)^{th} PO. The PDCCH monitoring occasions for paging are determined based on paging search space configuration (paging-SearchSpace) signaled by a gNB. The PDCCH monitoring occasions for paging which are not overlapping with UL symbols (determined according to tdd-UL-DL-ConfigurationCommon) are sequentially numbered from zero starting from the 1st PDCCH monitoring occasion for paging in the PF. The gNB may signal parameter firstPDCCH-MonitoringOccasionOfPO for each PO corresponding to a PF. When firstPDCCH-MonitoringOccasionOfPO is signalled, the (i_s+1)^{th} PO is a set of “S” consecutive PDCCH monitoring occasions for paging starting from the PDCCH monitoring occasion number indicated by firstPDCCH-MonitoringOccasionOfPO (i.e., the (i_s+1)^{th} value of the firstPDCCH-MonitoringOccasionOfPO parameter). Otherwise, the (i_s+1)^{th} PO is a set of “S” consecutive PDCCH monitoring occasions for paging starting from the (i_s*S)^{th} PDCCH monitoring occasion for paging. “S” is the number of actual transmitted SSBs determined according to parameter ssb-PositionsInBurst signalled in SystemInformationBlockI received from a gNB. The parameter first-PDCCH-MonitoringOccasionOfPO is signalled in SIB1 for paging in initial DL BWP. For paging in a DL BWP other than the initial DL BWP, the parameter first-PDCCH-MonitoringOccasionOfPO is signaled in the corresponding BWP configuration.

The design of 5G wireless communication system needs to support operation on licensed as well as unlicensed carrier(s). The main motivation of using unlicensed carrier is CAPEX reduction for cellular operators by utilizing free spectrum access for intelligent data offloading; improved and intelligent spectrum access and management, to address increasing wireless traffic demand under limited available spectrum and allowing network operators without licensed spectrum to utilize the radio efficient 3GPP radio access technology. Various deployment scenarios are being considered for operation on unlicensed carrier(s) such as:
NR-U LAA: Carrier aggregation between licensed band NR (PCell) and unlicensed band NR-U (SCell);
NR-U SA: Stand-alone NR-U;
ENU-DC: Dual connectivity between licensed band LTE (PCell) and unlicensed band NR-U (PSCell);
NNU-DC: Dual connectivity between licensed band NR (PCell) and unlicensed band NR-U (PSCell);
Note that the scenarios above include an NR cell with DL in unlicensed band and UL in licensed band.

Listen-before-talk (LBT) procedure is vital for fair and friendly coexistence of devices and technologies operating in unlicensed/shared spectrum. LBT procedures on a node attempting to transmit on a carrier in unlicensed spectrum require the node to perform a clear channel assessment to determine if the channel is free for use. The various types or categories of LBT procedures used for transmission are as follows:

### Category 1: No LBT;

No LBT procedure is performed by the transmitting entity; and

Category 2: LBT without Random Back-Off.

The duration of time that the channel is sensed to be idle before the transmitting entity transmits is deterministic. In an example sensing interval can be 25 us i.e., a UE can transmit, after sensing the channel to be idle for at least a sensing interval Td=25 us. For UL transmission category 3 is also referred as Type 2 channel access procedure.

Category 3: LBT with Random Back-Off with a Contention Window of Fixed Size.

The LBT procedure has the following procedure as one of its components. The transmitting entity draws a random number N within a contention window. The size of the contention window is specified by the minimum and maximum value of N. The size of the contention window is fixed. The random number N is used in the LBT procedure to determine the duration of time that the channel is sensed to be idle before the transmitting entity transmits on the channel. The detailed category 3 LBT procedure is as follows:

A UE transmits after sensing the channel to be idle during the slot durations of a defer duration (Td); and after the counter is zero in step 4. The detailed procedure is as follows:

Step 1: set N=Ninit, where Ninit is a random number uniformly distributed between 0 and CWp. CWp is the contention window for a given channel access priority class “p.” The various LBT parameters for different channel access priority class (CAPC) is listed in Table 1 below.

TABLE 1

| Channel | | | | | | |
|---|---|---|---|---|---|---|
| Access | | | | | | |
| Priority | | | | | | allowed |
| Class (p) | mₚ | CW_{min,} p | CW_{max,} p | T_{m cot, p} | | CWₚsizes |
| 1 | 1 | 3 | 7 | 2 | ms | {3, 7} |
| 2 | 1 | 7 | 15 | 3 | ms | {7, 15} |
| 3 | 3 | 15 | 63 | 8 or 10 | ms | {15, 31, 63} |
| 4 | 7 | 15 | 1023 | 8 or 10 | ms | {15, 31, 63, 127, |
| | | | | | | 255, 511, 1023} |

If the absence of any other technology sharing the carrier can be guaranteed on a long term basis (e.g., by level of regulation), the maximum channel occupancy time for LBT priority classes 3 and 4 is for 10 msec. Otherwise, maximum channel occupancy time for LBT priority classes 3 and 4 is for 8 msec.

Step 2: if N>0, decrement the counter, set N=N−1.

Step 3: Sense the channel for an additional slot duration (Ts). If the additional slot duration is idle, go to step 4 else, go to step 5.

Step 4: if N=0, perform transmission, Else, go to step 2.

Step 5: sense the channel during the slot durations of an additional defer duration Td. Defer duration (Td) is equal to Tf+mp×Ts, where Tf is equal to 16 us and Ts is equal to 9 us.

Step 6: If the channel is sensed to be idle during Td, go to step 2, Else, go to step 5.

Category 4: LBT with Random Back-Off with a Contention Window of Variable Size.

The LBT procedure has the following as one of its components. The transmitting entity draws a random number N within a contention window. The size of contention window is specified by the minimum and maximum value of N. The transmitting entity can vary the size of the contention window when drawing the random number N. The random number N is used in the LBT procedure to determine the duration of time that the channel is sensed to be idle before the transmitting entity transmits on the channel. The detailed procedure is same as category 3. Only difference is that in category 3 size of contention window is fixed whereas in category 4 the transmitting entity can vary the size of the contention window when drawing the random number N. For UL transmission category 4 is also referred as Type 1 channel access procedure.

Application Layer Measurement Reporting in fifth generation wireless communication system: a UE capable of application layer measurement reporting in an RRC_CONNECTED state may initiate the procedure when configured with application layer measurement, i.e., when appLayerMeasConfig and SRB4 have been configured by the network. This functionality is supported only for licensed spectrum. Table 2 below shows an example of message sent by a UE to a gNB for application layer measurement reporting.

```
TABLE 2
- MeasurementReportAppLayer
The MeasurementReportAppLayer message is used for sending application layer measurement
report.
    Signalling radio bearer: SRB4
    RLC-SAP: AM
    Logical channel: DCCH
    Direction: UE to Network
MeasurementReportAppLayer message
-- ASN1START
-- TAG-MEASUREMENTREPORTAPPLAYER-START
```

| | |
|---|---|
| MeasurementReportAppLayer-r17 ::= | SEQUENCE { |
| criticalExtensions | CHOICE { |
| measurementReportAppLayer-r17 | MeasurementReportAppLayer-r17-IEs, |
| criticalExtensionsFuture | SEQUENCE { } |

}
}

| MeasurementReportAppLayer-r17-IEs ::= | SEQUENCE { | |
|---|---|---|
| measurementReportAppLayerList-r17 | MeasurementReportAppLayerList-r17, | |
| lateNonCriticalExtension | OCTET STRING | OPTIONAL, |
| nonCriticalExtension | SEQUENCE{ } | OPTIONAL |

}

| | |
|---|---|
| MeasurementReportAppLayerList-r17 ::= | SEQUENCE (SIZE (1..maxNrofAppLayerMeas- |

r17)) OF MeasReportAppLayer-r17

| MeasReportAppLayer-r17 ::= | SEQUENCE { | |
|---|---|---|
| measConfigAppLayerId-r17 | MeasConfigAppLayerId-r17, | |
| measReportAppLayerContainer-r17 | OCTET STRING | OPTIONAL, |
| appLayerSessionStatus-r17 | ENUMERATED {start, stop} | OPTIONAL, |
| ran-VisibleMeasurements-r17 | RAN-VisibleMeasurements-r17 | OPTIONAL |

}

| RAN-VisibleMeasurements-r17 ::= | SEQUENCE { |
|---|---|
| appLayerBufferLevelList-r17 | SEQUENCE (SIZE (1..8)) OF AppLayerBufferLevel-r17 |

OPTIONAL,

| | | |
|---|---|---|
| playoutDelayForMediaStartup-r17 | INTEGER (0..30000) | OPTIONAL, |

| | |
|---|---|
| pdu-SessionIdList-r17 | SEQUENCE (SIZE (1..maxNrofPDU-Sessions-r17)) OF PDU- |

SessionID OPTIONAL,
...
}
AppLayerBufferLevel-r17 ::= INTEGER (0..30000)
-- TAG-MEASUREMENTREPORTAPPLAYER-STOP
-- ASN1STOP

Table 3 below shows an example of UE capabilities sent by a UE to a gNB for application layer measurement reporting.

TABLE 3
- AppLayerMeasParameters
The IE AppLayerMeasParameters is used to convey the capabilities supported by the UE for
application layer measurements.
AppLayerMeasParameters information element
-- ASN1START
-- TAG-APPLAYERMEASPARAMETERS-START

| AppLayerMeasParameters-r17 ::= | SEQUENCE { | |
|---|---|---|
| qoe-Streaming-MeasReport-r17 | ENUMERATED {supported} | OPTIONAL, |
| qoe-MTSI-MeasReport-r17 | ENUMERATED {supported} | OPTIONAL, |
| qoe-VR-MeasReport-r17 | ENUMERATED {supported} | OPTIONAL, |
| ran-VisibleQoE-Streaming-MeasReport-r17 | ENUMERATED | {supported} |

OPTIONAL,

| | | |
|---|---|---|
| ran-VisibleQoE-VR-MeasReport-r17 | ENUMERATED | {supported} |

OPTIONAL,

| | | |
|---|---|---|
| ul-MeasurementReportAppLayer-Seg-r17 | ENUMERATED | {supported} |

OPTIONAL,
...
}
-- TAG-APPLAYERMEASPARAMETERS-STOP
-- ASN1STOP

Table 4 below shows an example of configuration sent by a gNB to a UE for application layer measurement reporting.

TABLE 4
- AppLayerMeasConfig
The IE AppLayerMeasConfig indicates configuration of application layer measurements.
AppLayerMeasConfig information element
-- ASN1START
-- TAG-APPLAYERMEASCONFIG-START

| AppLayerMeasConfig-r17 ::= | SEQUENCE { | |
|---|---|---|
| measConfigAppLayerToAddModList-r17 | | SEQUENCE (SIZE (1..maxNrofAppLayerMeas- |
| r17)) OF MeasConfigAppLayer-r17 | OPTIONAL, -- Need N | |
| measConfigAppLayerToReleaseList-r17 | | SEQUENCE (SIZE (1..maxNrofAppLayerMeas- |
| r17)) OF MeasConfigAppLayerId-r17 | OPTIONAL, -- Need N | |
| rrc-SegAllowed-r17 | ENUMERATED {enabled} | OPTIONAL, -- Need |

R
...
}

| | |
|---|---|
| MeasConfigAppLayer-r17 ::= | SEQUENCE { |
| measConfigAppLayerId-r17 | MeasConfigAppLayerId-r17, |

| | |
|---|---|
| measConfigAppLayerContainer-r17 | OCTET STRING (SIZE (1..8000)) |

OPTIONAL, -- Need N

| | |
|---|---|
| serviceType-r17 | ENUMERATED {streaming, mtsi, vr, spare5, spare4, spare3, spare2, |

spare1} OPTIONAL, -- Need M

| | | |
|---|---|---|
| pauseReporting-r17 | BOOLEAN | OPTIONAL, -- Need M |
| transmissionOfSessionStartStop-r17 | BOOLEAN | OPTIONAL, -- Need |

M

| | |
|---|---|
| ran-VisibleParameters-r17 | SetupRelease {RAN-VisibleParameters-r17} |

OPTIONAL, -- Cond ServiceType
...
}

| | |
|---|---|
| RAN-VisibleParameters-r17 ::= | SEQUENCE { |

| | |
|---|---|
| ran-VisiblePeriodicity-r17 | ENUMERATED {ms120, ms240, ms480, ms640, ms1024} |

OPTIONAL, -- Need S

| | | |
|---|---|---|
| numberOfBufferLevelEntries-r17 | INTEGER (1..8) | OPTIONAL, -- Need |

R

| | | |
|---|---|---|
| reportPlayoutDelayForMediaStartup-r17 | BOOLEAN | OPTIONAL, -- |

Need M
...
}
-- TAG-APPLAYERMEASCONFIG-STOP
-- ASN1STOP

Application layer measurement reporting is supported only for licensed spectrum. Enhancements are needed to support this functionality for unlicensed spectrum such that backward compatibility is maintained (i.e., old UE which supports this functionality only in licensed spectrum and new UEs which supports this functionality in both licensed and unlicensed spectrum may be able to operate in the cell and network may be able to distinguish them and configure application measurement accordingly.

FIG. 1 illustrates a signaling flow between a UE and a gNB for application layer measurement reporting according to an embodiment of the present disclosure.

Referring to FIG. 1, a method for application layer measurement reporting is illustrated, wherein the CAPC of SRB4 is configured by an RRC Reconfiguration message. The following operations are disclosed for the sake of clarity and ease of comprehension. It should be understood that not all of these operations are essential to the disclosure, and certain operations may be selectively omitted as appropriate.

In operation 100, a UE may be in an RRC_CONNECTED state. In operation 105 a gNB may send UE capability enquiry to enquire about the UE capabilities (UE capability enquiry message may request for UE capabilities for application layer measurement reporting). In operation 110, the UE may send the UE capability information message wherein the message includes UE capabilities for application layer measurement reporting. The UE capabilities may indicate whether the UE supports application layer measurement reporting on unlicensed spectrum. The gNB may support one or more serving cells for the UE.

In operation 115, if there is at least one unlicensed serving cell (i.e., cell operating on or using unlicensed spectrum) configured by the gNB to the UE and application layer measurement reporting in unlicensed spectrum is supported by the UE, the gNB may configure SRB4, AppLayerMeasConfig and CAPC for LCH of SRB4 to the UE. In operation 120, the gNB may send these configurations to the UE in an RRCReconfiguration message. Alternatively, if there is no unlicensed serving cell configured by the gNB to the UE, the gNB may configure SRB4 and AppLayerMeasConfig to the UE and send these configurations to UE in the RRCReconfiguration message. Alternatively, if there is at least one unlicensed serving cell (i.e., cell operating on or using unlicensed spectrum) configured by the gNB to the UE and application layer measurement reporting in unlicensed spectrum is not supported by the UE, the gNB may not configure SRB4 and AppLayerMeasConfig to the UE.

In operation 125, upon receiving the RRCReconfiguration message with AppLayerMeasConfig, the UE (or RRC layer in UE) may inform the application layer about the configuration of application layer measurement reporting. In operation 130, the UE (or RRC layer in UE) may receive the application layer measurement report from the application layer. In operation 135, the UE (or RRC layer in a UE) may generate a MeasurementReportAppLayer0 message for transmission using the SRB4. In operation 140, the UE (or MAC layer in a UE) may generate a MAC PDU including the MAC SDU for the MeasurementReportAppLayer message. The UE may determine to transmit the MAC PDU in UL grant (configured grant or dynamic grant).

In operation 145, if UL grant for transmitting the MAC PDU is for unlicensed cell and CAPC is not indicated by a gNB for this UL grant, the UE (or MAC layer in a UE) may determine the CAPC of MAC PDU considering the CAPC of SRB4 received in an RRC message and CAPC of other MAC SDUs (i.e., CAPC of RBs of other MAC SDUs) included in MAC PDU, if any. In operation 150, the UE (or MAC layer in a UE) may transmit the MAC PDU after accessing the channel based on determined CAPC of the MAC PDU.

Determination of the CAPC of MAC PDU: The Channel Access Priority Classes (CAPC) of radio bearers and MAC CEs are either fixed or configurable:
Fixed to the lowest priority for the padding BSR and recommended bit rate MAC CEs;
Fixed to the highest priority for SRB0, SRB1, SRB3 and other MAC CEs; and/or
Configured by the gNB for SRB2, SRB4 and DRB.

When performing Type 1 LBT for the transmission of an uplink TB and when the CAPC is not indicated in the DCI, the UE may select the CAPC as follows:
If only MAC CE(s) is included in the TB, the highest priority CAPC of those MAC CE(s) is used;
If CCCH SDU(s) are included in the TB, the highest priority CAPC (i.e., CAPC 1) is used (or the highest priority CAPC of the CCCH SDU(s) is used);
If DCCH SDU(s) are included in the TB, the highest priority CAPC of the DCCH SDU(s) is used; and/or
The lowest priority CAPC of the logical channel(s) with MAC SDU multiplexed in the TB is used otherwise.

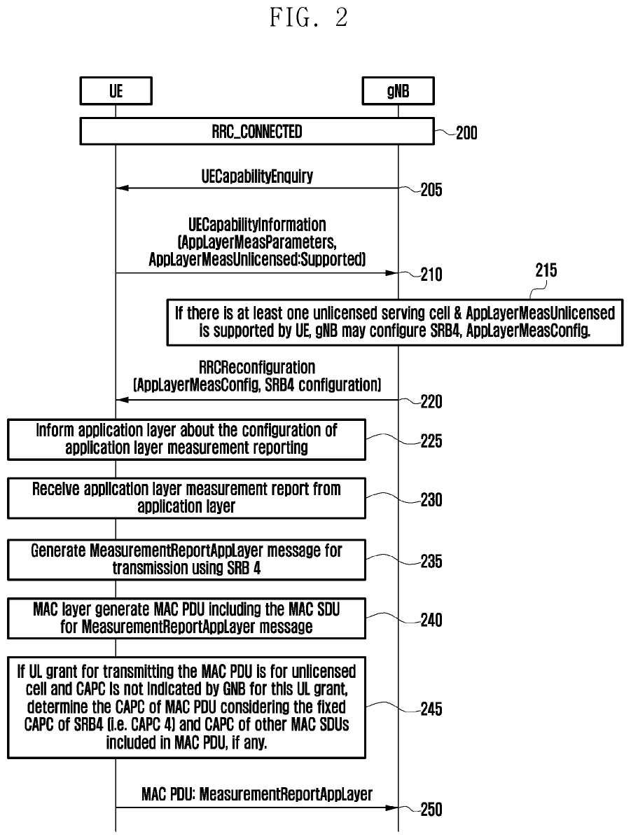

FIG. 2 illustrates a signaling flow between a UE and a gNB for application layer measurement reporting according to an embodiment of the present disclosure.

Referring to FIG. 2, a method for application layer measurement reporting is illustrated, wherein the CAPC of SRB4 is fixed or predetermined. The following operations are disclosed for the sake of clarity and ease of comprehension. It should be understood that not all of these operations are essential to the disclosure, and certain operations may be selectively omitted as appropriate.

In operation 200, a UE may be in an RRC_CONNECTED state. In operation 205 a gNB may send UE capability enquiry to enquire about the UE capabilities (UE capability enquiry message may request for UE capabilities for application layer measurement reporting). In operation 210, the UE may send the UE capability information message wherein the message includes UE capabilities for application layer measurement reporting. The UE capabilities may indicate whether the UE supports application layer measurement reporting on unlicensed spectrum. The gNB may support one or more serving cells for the UE.

In operation 215, if there is at least one unlicensed serving cell (i.e., cell operating on or using unlicensed spectrum) configured by the gNB to the UE and application layer measurement reporting in unlicensed spectrum is supported by the UE, the gNB may configure SRB4 and AppLayerMeasConfig to the UE. In operation 220, the gNB may send these configurations to the UE in an RRCReconfiguration message. Alternatively, if there is no unlicensed serving cell configured by the gNB to the UE, the gNB may configure SRB4 and AppLayerMeasConfig to the UE and send these configurations to the UE in the RRCReconfiguration message. Alternatively, if there is at least one unlicensed serving cell (i.e., cell operating on or using unlicensed spectrum) configured by the gNB to the UE and application layer measurement reporting in unlicensed spectrum is not supported by the UE, the gNB may not configure SRB4 and AppLayerMeasConfig to the UE.

In operation 225, upon receiving the RRCReconfiguration message with AppLayerMeasConfig, the UE (or RRC layer in a UE) may inform the application layer about the configuration of application layer measurement reporting. In operation 230, the UE (or RRC layer in a UE) may receive the application layer measurement report from the application layer. In operation 235, the UE (or RRC layer in a UE) may generate a MeasurementReportAppLayer message for transmission using the SRB4. In operation 240, the UE (or MAC layer in a UE) may generate a MAC PDU including the MAC SDU for the MeasurementReportAppLayer message. The UE may determine to transmit the MAC PDU in UL grant (configured grant or dynamic grant).

In operation 245, if UL grant for transmitting the MAC PDU is for unlicensed cell and CAPC is not indicated by a gNB for this UL grant, the UE (or MAC layer in a UE) may determine the CAPC of MAC PDU considering the fixed CAPC of SRB4 (e.g., CAPC 4 or CAPC 3 or CAPC 2 or CAPC 1) and CAPC of other MAC SDUs (i.e., CAPC of RBs of other MAC SDUs) included in MAC PDU, if any. In operation 250, the UE (or MAC layer in a UE) may transmit the MAC PDU after accessing the channel based on determined CAPC of the MAC PDU.

Determination of the CAPC of MAC PDU: The Channel Access Priority Classes (CAPC) of radio bearers and MAC CEs are either fixed or configurable:
Fixed to the lowest priority for the padding BSR and recommended bit rate MAC CEs;
Fixed to the highest priority for SRB0, SRB1, SRB3, SRB4 and other MAC CEs; and/or
Configured by the gNB for SRB2 and DRB.

When performing Type 1 LBT for the transmission of an uplink TB and when the CAPC is not indicated in the DCI, the UE may select the CAPC as follows:
If only MAC CE(s) is included in the TB, the highest priority CAPC of those MAC CE(s) is used;
If CCCH SDU(s) are included in the TB, the highest priority CAPC (i.e., CAPC 1) is used (or the highest priority CAPC of the CCCH SDU(s) is used);
If DCCH SDU(s) are included in the TB, the highest priority CAPC of the DCCH SDU(s) is used; and/or

The lowest priority CAPC of the logical channel(s) with MAC SDU multiplexed in the TB is used otherwise.

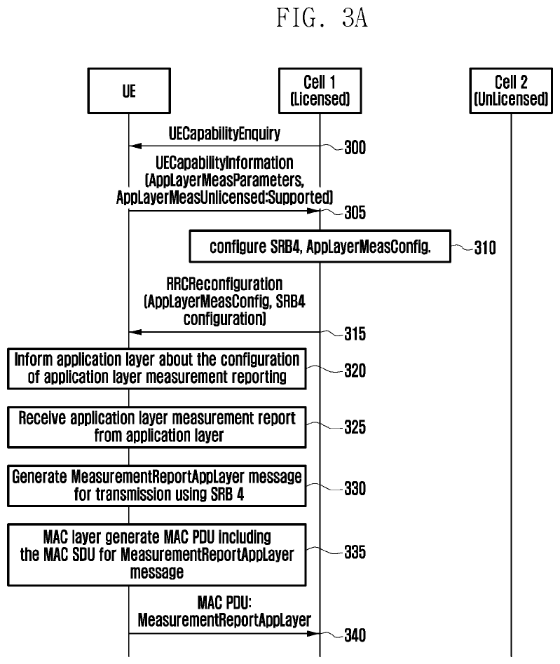

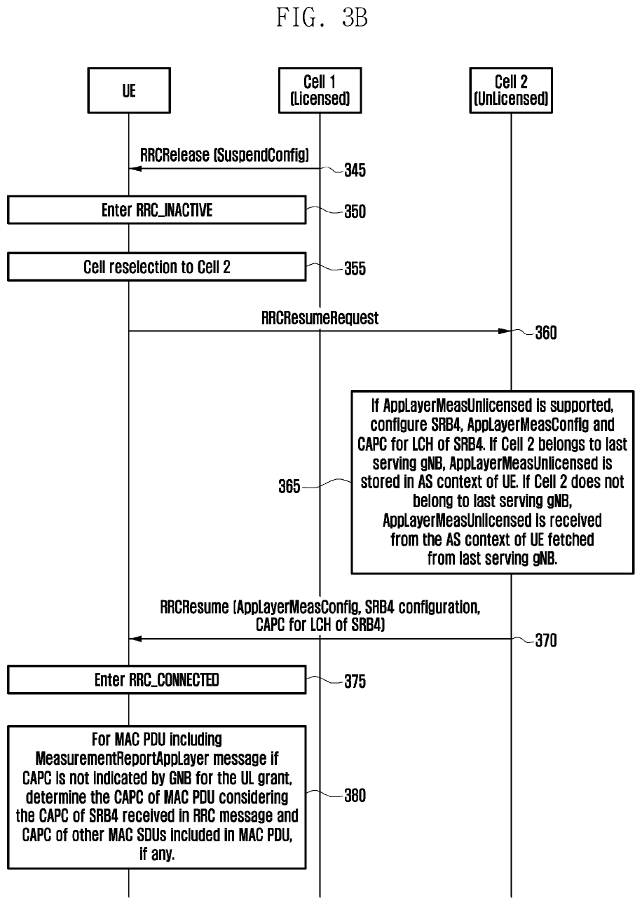

FIGS. 3A and 3B illustrate signaling flows between a UE and a gNB for application layer measurement reporting according to an embodiment of the present disclosure.

Referring to FIGS. 3A and 3B, a method for application layer measurement reporting in a resume operation is illustrated, wherein the CAPC of SRB4 is configured by an RRC resume message. The following operations are disclosed for the sake of clarity and ease of comprehension. It should be understood that not all of these operations are essential to the disclosure, and certain operations may be selectively omitted as appropriate.

In operation 300, Cell 1 in licensed spectrum may send a UE in an RRC_CONNECTED state a capability enquiry message to enquire about the UE capabilities (e.g., a UE capability enquiry message may request for UE capabilities for application layer measurement reporting). In operation 305, the UE may send the UE capability information message, wherein the message includes the UE capabilities for application layer measurement reporting. The UE capabilities indicate whether the UE supports application layer measurement reporting on unlicensed spectrum. In 310, Cell 1 may configure SRB4 and AppLayerMeasConfig to the UE. In operation 315, Cell 1 may send these configurations to the UE in an RRCReconfiguration message.

In operation 320, upon receiving the RRCReconfiguration message with AppLayerMeasConfig, the UE (or RRC layer in a UE) may inform the application layer about the configuration of application layer measurement reporting. In operation 325, the UE (or RRC layer in a UE) may receive the application layer measurement report from the application layer. In operation 330, the UE (or RRC layer in a UE) may generate a MeasurementReportAppLayer message for transmission using the SRB4. In operation 335, the UE (or MAC layer in a UE) may generate a MAC PDU including the MAC SDU for the MeasurementReportAppLayer message. In operation 340, the UE may transmit the MAC PDU to Cell 1 in UL grant (configured grant or dynamic grant).

In operation 345, the UE may receive an RRCRelease message from Cell 1, wherein the message includes suspend configuration. In operation 350, the UE may enter an RRC_INACTIVE state. In operation 355, while in the RRC_INACTIVE state, the UE may perform cell reselection to Cell 2 operating on unlicensed spectrum. While the UE is camped to Cell 2, connection resumption is initiated by the UE. In operation 360, the UE may transmit RRCResumeRequest to Cell 2. In operation 365, if application layer measurement reporting in unlicensed spectrum is supported by the UE, Cell 2 may configure SRB4, AppLayerMeasConfig and CAPC for LCH of SRB4 to the UE. In operation 370, Cell 2 may send these configurations to the UE in an RRCResume message. Here, if Cell 2 belongs to the last serving gNB, AppLayerMeasUnlicensed is stored in AS context of the UE. Alternatively, if Cell 2 does not belong to the last serving gNB, AppLayerMeasUnlicensed is received in the AS context of UE fetched from the last serving gNB.

In operation 375, upon receiving the RRCResume, the UE may enter an RRC_CONNECTED. Upon receiving the RRCResume message with AppLayerMeasConfig, the UE (or RRC layer in a UE) may inform the application layer about the configuration of application layer measurement reporting. The UE (or RRC layer in a UE) may receive the application layer measurement report from the application layer. The UE (or RRC layer in a UE) may generate a MeasurementReportAppLayer message for transmission using the SRB4. The UE (or MAC layer in a UE) may generate a MAC PDU including the MAC SDU for the MeasurementReportAppLayer message. The UE may determine to transmit the MAC PDU in UL grant (configured grant or dynamic grant).

In operation 380, if CAPC is not indicated by a gNB for UL grant (configured grant or dynamic grant), the UE (or MAC layer in UE) may determine the CAPC of MAC PDU considering the CAPC of SRB4 received in an RRC message and CAPC of other MAC SDUs (i.e., CAPC of RBs of other MAC SDUs) included in MAC PDU, if any. The UE (or MAC layer in a UE) may transmit the MAC PDU after accessing the channel based on determined CAPC of the MAC PDU.

Determination of the CAPC of MAC PDU: The Channel Access Priority Classes (CAPC) of radio bearers and MAC CEs are either fixed or configurable:
Fixed to the lowest priority for the padding BSR and recommended bit rate MAC CEs;
Fixed to the highest priority for SRB0, SRB1, SRB3 and other MAC CEs; and/pr
Configured by the gNB for SRB2, SRB4 and DRB.

When performing Type 1 LBT for the transmission of an uplink TB and when the CAPC is not indicated in the DCI, the UE may select the CAPC as follows:
If only MAC CE(s) is included in the TB, the highest priority CAPC of those MAC CE(s) is used;
If CCCH SDU(s) are included in the TB, the highest priority CAPC (i.e., CAPC 1) is used (or the highest priority CAPC of the CCCH SDU(s) is used);
If DCCH SDU(s) are included in the TB, the highest priority CAPC of the DCCH SDU(s) is used; and/or
The lowest priority CAPC of the logical channel(s) with MAC SDU multiplexed in the TB is used otherwise.

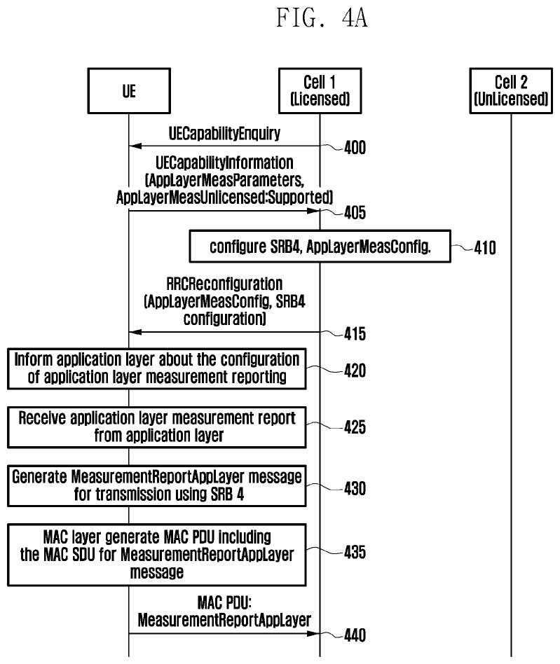

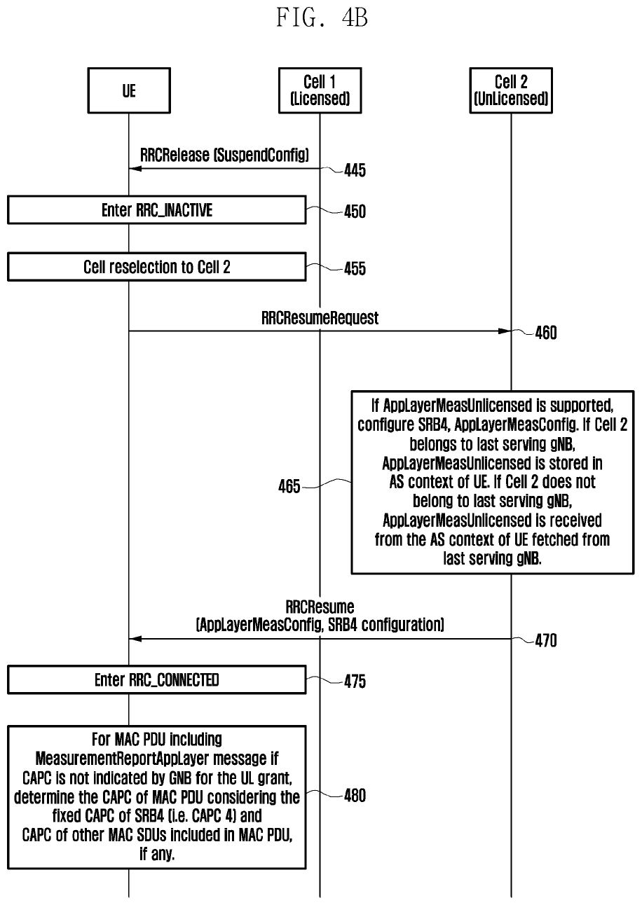

FIGS. 4A and 4B illustrate signaling flows between a UE and a gNB for application layer measurement reporting according to an embodiment of the present disclosure.

Referring to FIGS. 4A and 4B, a method for application layer measurement reporting in a resume operation is illustrated, wherein the CAPC of SRB4 is fixed or predetermined. The following operations are disclosed for the sake of clarity and ease of comprehension. It should be understood that not all of these operations are essential to the disclosure, and certain operations may be selectively omitted as appropriate.

In operation 400, Cell 1 in licensed spectrum may send a UE in an RRC_CONNECTED state a capability enquiry message to enquire about the UE capabilities (e.g., a UE capability enquiry message may request for UE capabilities for application layer measurement reporting). In operation 405, the UE may send the UE capability information message, wherein the message includes the UE capabilities for application layer measurement reporting. The UE capabilities indicate whether the UE supports application layer measurement reporting on unlicensed spectrum. In 410, Cell 1 may configure SRB4 and AppLayerMeasConfig to the UE. In operation 415, Cell 1 may send these configurations to the UE in an RRCReconfiguration message.

In operation 420, upon receiving the RRCReconfiguration message with AppLayerMeasConfig, the UE (or RRC layer in a UE) may inform the application layer about the configuration of application layer measurement reporting. In operation 425, the UE (or RRC layer in a UE) may receive the application layer measurement report from the application layer. In operation 430, the UE (or RRC layer in a UE) may generate a MeasurementReportAppLayer message for transmission using the SRB4. In operation 435, the UE (or MAC layer in a UE) may generate a MAC PDU including the MAC SDU for the MeasurementReportAppLayer message. In operation 440, the UE may transmit the MAC PDU to Cell 1 in UL grant (configured grant or dynamic grant).

In operation 445, the UE may receive an RRCRelease message from Cell 1, wherein the message includes suspend configuration. In operation 450, the UE may enter an RRC_INACTIVE state. In operation 455, while in the RRC_INACTIVE state, the UE may perform cell reselection to Cell 2 operating on unlicensed spectrum. While the UE is camped to Cell 2, connection resumption is initiated by the UE. In operation 460, the UE may transmit RRCResumeRequest to Cell 2. In operation 465, if application layer measurement reporting in unlicensed spectrum is supported by the UE, Cell 2 may configure SRB4 and AppLayerMeasConfig to the UE. In operation 470, Cell 2 may send these configurations to the UE in the RRCResume message. Here, if Cell 2 belongs to the last serving gNB, AppLayerMeasUnlicensed is stored in AS context of the UE. Alternatively, if Cell 2 does not belong to the last serving gNB, AppLayerMeasUnlicensed is received in the AS context of UE fetched from the last serving gNB.

In operation 475, upon receiving the RRCResume, the UE may enter an RRC_CONNECTED state. Upon receiving the RRCResume message with AppLayerMeasConfig, the UE (or RRC layer in a UE) may inform the application layer about the configuration of application layer measurement reporting. The UE (or RRC layer in a UE) may receive the application layer measurement report from the application layer. The UE (or RRC layer in a UE) may generate a MeasurementReportAppLayer message for transmission using the SRB4. The UE (or MAC layer in a UE) may generate a MAC PDU including the MAC SDU for the MeasurementReportAppLayer message. The UE may determine to transmit the MAC PDU in UL grant (configured grant or dynamic grant).

In operation 480, if CAPC is not indicated by a gNB for UL grant (configured grant or dynamic grant), the UE (or MAC layer in a UE) may determine the CAPC of MAC PDU considering the fixed CAPC of SRB4 (e.g., CAPC 4 or CAPC 3 or CAPC 2 or CAPC 1) and CAPC of other MAC SDUs (i.e., CAPC of RBs of other MAC SDUs) included in MAC PDU, if any. The UE (or MAC layer in a UE) may transmit the MAC PDU after accessing the channel based on determined CAPC of the MAC PDU.

Determination of the CAPC of MAC PDU: The Channel Access Priority Classes (CAPC) of radio bearers and MAC CEs are either fixed or configurable:
Fixed to the lowest priority for the padding BSR and recommended bit rate MAC CEs;
Fixed to the highest priority for SRB0, SRB1, SRB3, SRB4 and other MAC CEs; and/or
Configured by the gNB for SRB2 and DRB.

When performing Type 1 LBT for the transmission of an uplink TB and when the CAPC is not indicated in the DCI, the UE may select the CAPC as follows:
If only MAC CE(s) is included in the TB, the highest priority CAPC of those MAC CE(s) is used;
If CCCH SDU(s) are included in the TB, the highest priority CAPC (i.e., CAPC 1) is used (or the highest priority CAPC of the CCCH SDU(s) is used);
If DCCH SDU(s) are included in the TB, the highest priority CAPC of the DCCH SDU(s) is used; and/or
The lowest priority CAPC of the logical channel(s) with MAC SDU multiplexed in the TB is used otherwise.

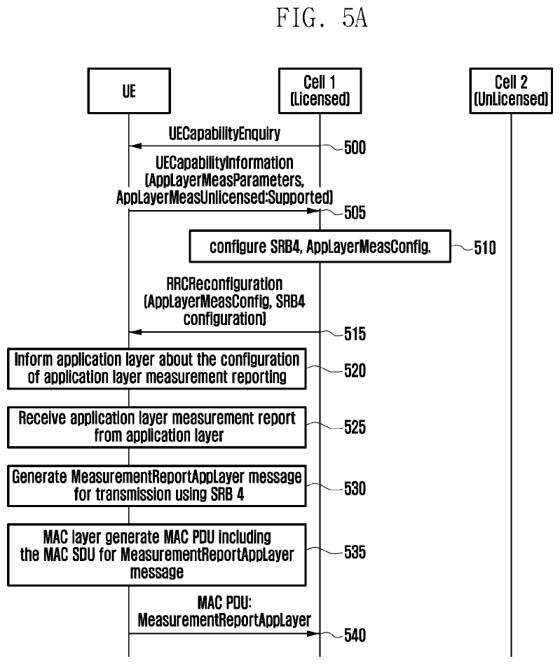

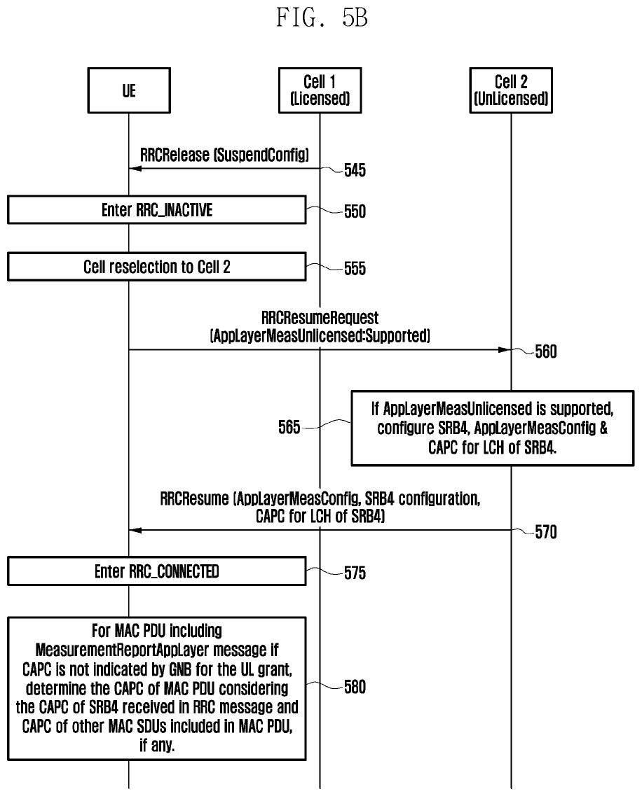

FIGS. 5A and 5B illustrate signaling flows between a UE and a gNB for application layer measurement reporting according to an embodiment of the present disclosure.

Referring to FIGS. 5A and 5B, a method for application layer measurement reporting in a resume operation is illustrated, wherein the CAPC of SRB4 is configured by an RRC resume message and the support for application layer measurement in unlicensed spectrum is indicated by an RRC resume request message. The following operations are disclosed for the sake of clarity and ease of comprehension. It should be understood that not all of these operations are essential to the disclosure, and certain operations may be selectively omitted as appropriate.

In operation 500, Cell 1 in licensed spectrum may send a UE in RRC_CONNECTED state a capability enquiry message to enquire about the UE capabilities (e.g., a UE capability enquiry message may request for UE capabilities for application layer measurement reporting). In operation 505, the UE may send the UE capability information message, wherein the message includes the UE capabilities for application layer measurement reporting. The UE capabilities indicate whether the UE supports application layer measurement reporting on unlicensed spectrum. In 510, Cell 1 may configure SRB4 and AppLayerMeasConfig to the UE. In operation 515, Cell 1 may send these configurations to the UE in an RRCReconfiguration message.

In operation 520, upon receiving the RRCReconfiguration message with AppLayerMeasConfig, the UE (or RRC layer in a UE) may inform the application layer about the configuration of application layer measurement reporting. In operation 525, the UE (or RRC layer in a UE) may receive the application layer measurement report from the application layer. In operation 530, the UE (or RRC layer in a UE) may generate a MeasurementReportAppLayer message for transmission using the SRB4. In operation 535, the UE (or MAC layer in a UE) may generate a MAC PDU including the MAC SDU for the MeasurementReportAppLayer message. In operation 540, the UE may transmit the MAC PDU to Cell 1 in UL grant (configured grant or dynamic grant).

In operation 545, the UE may receive an RRCRelease message from Cell 1, wherein the message includes suspend configuration. In operation 550, the UE may enter an RRC_INACTIVE state. In operation 555, while in the RRC_INACTIVE state, the UE may perform cell reselection to Cell 2 operating on unlicensed spectrum. While the UE is camped to Cell 2, connection resumption is initiated by the UE. In operation 560, the UE may transmit an RRCResumeRequest to Cell 2. The UE may indicate in the RRCResumeRequest whether the UE supports application layer measurement reporting on unlicensed spectrum. In operation 565, if application layer measurement reporting in unlicensed spectrum is supported by the UE, Cell 2 may configure SRB4, AppLayerMeasConfig and CAPC for LCH of SRB4 to the UE. In operation 570, Cell 2 may send these configurations to the UE in an RRCResume message.

In operation 575, upon receiving the RRCResume, the UE may enter an RRC_CONNECTED state. Upon receiving the RRCResume message with AppLayerMeasConfig, the UE (or RRC layer in a UE) may inform the application layer about the configuration of application layer measurement reporting. The UE (or RRC layer in a UE) may receive the application layer measurement report from the application layer. The UE (or RRC layer in a UE) may generate a MeasurementReportAppLayer message for transmission using the SRB4. The UE (or MAC layer in a UE) may generate a MAC PDU including the MAC SDU for the MeasurementReportAppLayer message. The UE may determine to transmit the MAC PDU in UL grant (configured grant or dynamic grant).

In operation 580, if CAPC is not indicated by a gNB for UL grant (configured grant or dynamic grant), the UE (or MAC layer in a UE) may determine the CAPC of MAC PDU considering the CAPC of SRB4 received in an RRC message and CAPC of other MAC SDUs (i.e., CAPC of RBs of other MAC SDUs) included in MAC PDU, if any. The UE (or MAC layer in a UE) may transmit the MAC PDU after accessing the channel based on determined CAPC of the MAC PDU.

Determination of the CAPC of MAC PDU: The Channel Access Priority Classes (CAPC) of radio bearers and MAC CEs are either fixed or configurable:
Fixed to the lowest priority for the padding BSR and recommended bit rate MAC CEs;
Fixed to the highest priority for SRB0, SRB1, SRB3 and other MAC CEs; and/or
Configured by the gNB for SRB2, SRB4 and DRB.

When performing Type 1 LBT for the transmission of an uplink TB and when the CAPC is not indicated in the DCI, the UE may select the CAPC as follows:
If only MAC CE(s) is included in the TB, the highest priority CAPC of those MAC CE(s) is used;
If CCCH SDU(s) are included in the TB, the highest priority CAPC (i.e., CAPC 1) is used (or the highest priority CAPC of the CCCH SDU(s) is used);
If DCCH SDU(s) are included in the TB, the highest priority CAPC of the DCCH SDU(s) is used; and/or
The lowest priority CAPC of the logical channel(s) with MAC SDU multiplexed in the TB is used otherwise.

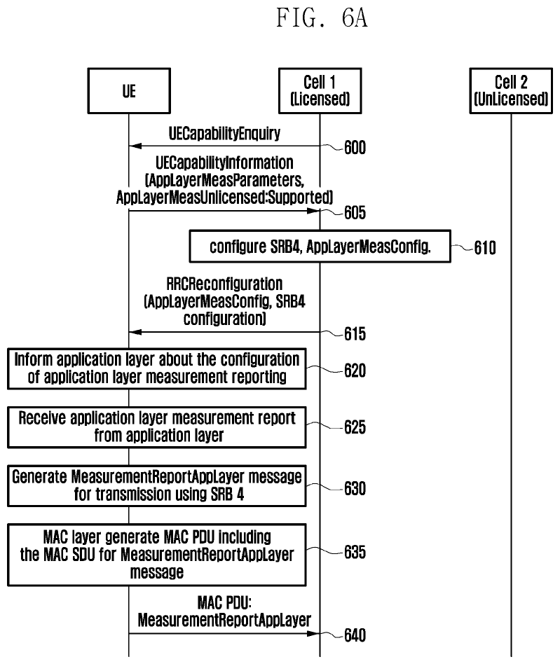

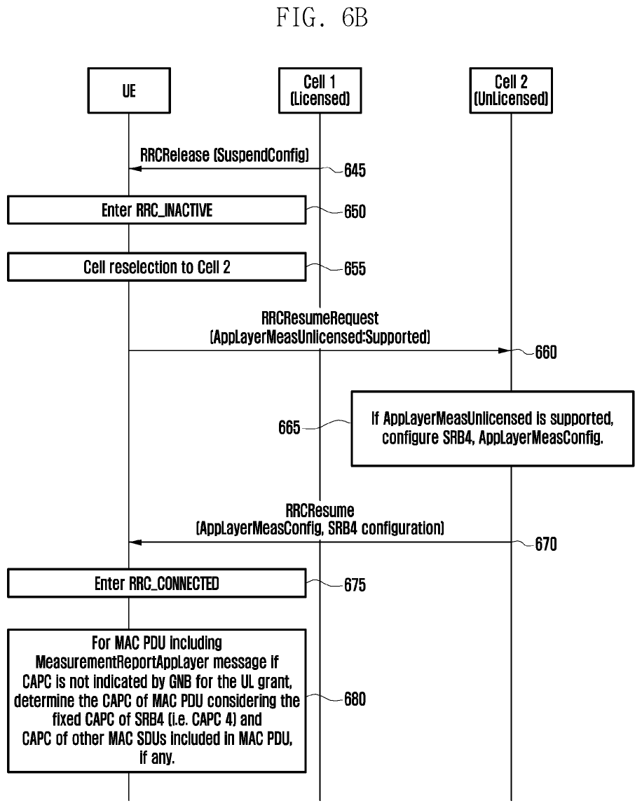

FIGS. 6A and 6B illustrate signaling flows between a UE and a gNB for application layer measurement reporting according to an embodiment of the present disclosure.

Referring to FIGS. 6A and 6B, a method for application layer measurement reporting in a resume operation is illustrated, wherein the CAPC of SRB4 is fixed or predetermined and the support for application layer measurement in unlicensed spectrum is indicated by an RRC resume request message. The following operations are disclosed for the sake of clarity and ease of comprehension. It should be understood that not all of these operations are essential to the disclosure, and certain operations may be selectively omitted as appropriate.

In operation 600, Cell 1 in licensed spectrum may send a UE in an RRC_CONNECTED state a capability enquiry message to enquire about the UE capabilities (e.g., a UE capability enquiry message may request for UE capabilities for application layer measurement reporting). In operation 605, the UE may send the UE capability information message, wherein the message includes the UE capabilities for application layer measurement reporting. The UE capabilities indicate whether the UE supports application layer measurement reporting on unlicensed spectrum. In 610, Cell 1 may configure SRB4 and AppLayerMeasConfig to the UE. In operation 415, Cell 1 may send these configurations to the UE in an RRCReconfiguration message.

In operation 620, upon receiving the RRCReconfiguration message with AppLayerMeasConfig, the UE (or RRC layer in a UE) may inform the application layer about the configuration of application layer measurement reporting. In operation 625, the UE (or RRC layer in a UE) may receive the application layer measurement report from the application layer. In operation 630, the UE (or RRC layer in a UE) may generate a MeasurementReportAppLayer message for transmission using the SRB4. In operation 635, the UE (or MAC layer in a UE) may generate a MAC PDU including the MAC SDU for the MeasurementReportAppLayer message. In operation 640, the UE may transmit the MAC PDU to Cell 1 in UL grant (configured grant or dynamic grant).

In operation 645, the UE may receive an RRCRelease message from Cell 1, wherein the message includes suspend configuration. In operation 650, the UE may enter an RRC_INACTIVE state. In operation 655, while in the RRC_INACTIVE state, the UE may perform cell reselection to Cell 2 operating on unlicensed spectrum. While the UE is camped to Cell 2, connection resumption is initiated by the UE. In operation 660, the UE may transmit RRCResumeRequest to Cell 2. The UE may indicate in the RRCResumeRequest whether the UE supports application layer measurement reporting on unlicensed spectrum. In operation 665, if application layer measurement reporting in unlicensed spectrum is supported by the UE, Cell 2 may configure SRB4 and AppLayerMeasConfig to the UE. In operation 470, Cell 2 may send these configurations to the UE in an RRCResume message.

In operation 675, upon receiving the RRCResume, the UE may enter an RRC_CONNECTED. Upon receiving the RRCResume message with AppLayerMeasConfig, the UE (or RRC layer in a UE) may inform the application layer about the configuration of application layer measurement reporting. The UE (or RRC layer in a UE) may receive the application layer measurement report from the application layer. The UE (or RRC layer in a UE) may generate a MeasurementReportAppLayer message for transmission using the SRB4. The UE (or MAC layer in a UE) may generate a MAC PDU including the MAC SDU for the MeasurementReportAppLayer message. The UE may determine to transmit the MAC PDU in UL grant (configured grant or dynamic grant).

In operation 680, if CAPC is not indicated by a gNB for UL grant (configured grant or dynamic grant), the UE (or MAC layer in a UE) may determine the CAPC of MAC PDU considering the fixed CAPC of SRB4 (e.g., CAPC 4 or CAPC 3 or CAPC 2 or CAPC 1) and CAPC of other MAC SDUs (i.e., CAPC of RBs of other MAC SDUs) included in MAC PDU, if any. The UE (or MAC layer in a UE) may transmit the MAC PDU after accessing the channel based on determined CAPC of the MAC PDU.

Determination of the CAPC of MAC PDU: The Channel Access Priority Classes (CAPC) of radio bearers and MAC CEs are either fixed or configurable:
Fixed to the lowest priority for the padding BSR and recommended bit rate MAC CEs;
Fixed to the highest priority for SRB0, SRB1, SRB3, SRB4 and other MAC CEs; and/or
Configured by the gNB for SRB2 and DRB.

When performing Type 1 LBT for the transmission of an uplink TB and when the CAPC is not indicated in the DCI, the UE may select the CAPC as follows:
If only MAC CE(s) is included in the TB, the highest priority CAPC of those MAC CE(s) is used;
If CCCH SDU(s) are included in the TB, the highest priority CAPC (i.e., CAPC 1) is used (or the highest priority CAPC of the CCCH SDU(s) is used);
If DCCH SDU(s) are included in the TB, the highest priority CAPC of the DCCH SDU(s) is used; and/or
The lowest priority CAPC of the logical channel(s) with MAC SDU multiplexed in the TB is used otherwise.

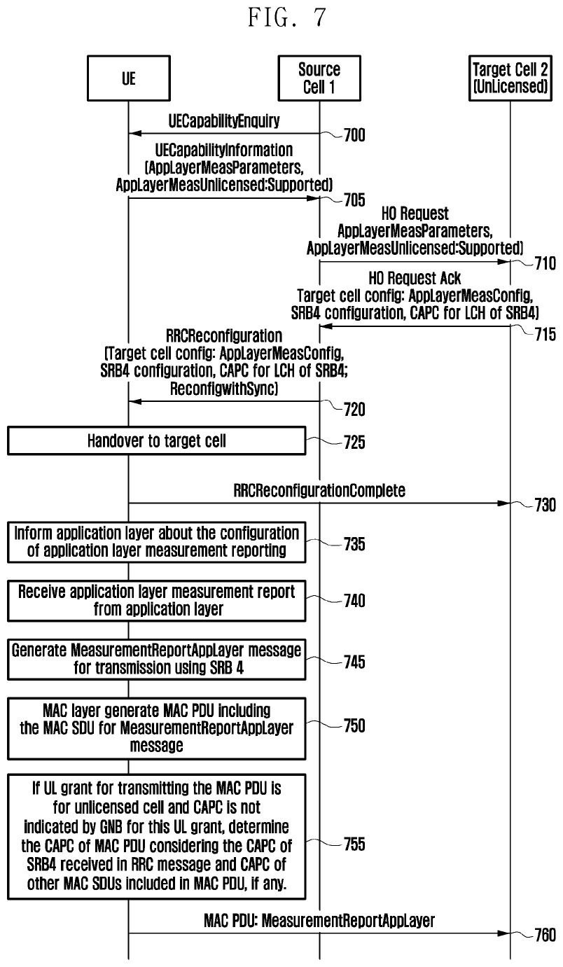

FIG. 7 illustrates a signaling flow between a UE and a gNB for application layer measurement reporting according to an embodiment of the present disclosure.

Referring to FIG. 7, a method for application layer measurement reporting in a handover scenario is illustrated, wherein the CAPC of SRB4 is configured by a handover command. The following operations are disclosed for the sake of clarity and ease of comprehension. It should be understood that not all of these operations are essential to the disclosure, and certain operations may be selectively omitted as appropriate.

In operation 700, Cell 1 (i.e., source cell/serving cell) may send a UE in an RRC_CONNECTED state a capability enquiry message to enquire about the UE capabilities (e.g., a UE capability enquiry message may request for UE capabilities for application layer measurement reporting). In operation 705, the UE may send the UE capability information message, wherein the message includes the UE capabilities for application layer measurement reporting. The UE capabilities indicate whether the UE supports application layer measurement reporting on unlicensed spectrum.

In operation 710 Cell 1 may send the UE capabilities (including whether the UE supports application layer measurement reporting on unlicensed spectrum) for application layer measurement reporting to Cell 2 (i.e., target cell) in a handover request message over Xn interface. Here, Cell 2 may operate in unlicensed spectrum. Cell 2 may configure SRB4, AppLayerMeasConfig and CAPC of LCH of SRB4 to the UE. In operation 715, Cell 2 may send these configurations to Cell 1 in a handover request ack message, if the UE supports application layer measurement reporting on unlicensed spectrum. In operation 720, Cell 1 may send these configurations to the UE in an RRCReconfiguration message with reconfiguration with sync (or handover command to handover to Cell 2). In operation 725, the UE may handover to Cell 2 by performing a random access procedure. In operation 730, the UE may send the RRCReconfiguration complete message to Cell 2.

In operation 735, the UE (or RRC layer in a UE) may also inform the application layer about the configuration of application layer measurement reporting of Cell 2 received from Cell 1. In operation 740, the UE (or RRC layer in a UE) may receive the application layer measurement report from the application layer. In operation 745, the UE (or RRC layer in a UE) may generate a MeasurementReportAppLayer message for transmission using the SRB4. In operation 750, the UE (or MAC layer in a UE) may generate a MAC PDU including the MAC SDU for the MeasurementReportAppLayer message. The UE may determine to transmits the MAC PDU to Cell 2 in UL grant (configured grant or dynamic grant).

In operation 755, if UL grant for transmitting the MAC PDU is for unlicensed cell and CAPC is not indicated by a gNB for the UL grant, the UE (or MAC layer in a UE) may determine the CAPC of MAC PDU considering the CAPC of SRB4 received in an RRC message and CAPC of other MAC SDUs (i.e., CAPC of RBs of other MAC SDUs) included in MAC PDU, if any. In operation 760, the UE (or MAC layer in a UE) may transmit the MAC PDU after accessing the channel based on determined CAPC of the MAC PDU.

Determination of the CAPC of MAC PDU: The Channel Access Priority Classes (CAPC) of radio bearers and MAC CEs are either fixed or configurable:
Fixed to the lowest priority for the padding BSR and recommended bit rate MAC CEs;
Fixed to the highest priority for SRB0, SRB1, SRB3 and other MAC CEs; and/pr
Configured by the gNB for SRB2, SRB4 and DRB.

When performing Type 1 LBT for the transmission of an uplink TB and when the CAPC is not indicated in the DCI, the UE may select the CAPC as follows:
If only MAC CE(s) is included in the TB, the highest priority CAPC of those MAC CE(s) is used;
If CCCH SDU(s) are included in the TB, the highest priority CAPC (i.e., CAPC 1) is used (or the highest priority CAPC of the CCCH SDU(s) is used);
If DCCH SDU(s) are included in the TB, the highest priority CAPC of the DCCH SDU(s) is used; and/or
The lowest priority CAPC of the logical channel(s) with MAC SDU multiplexed in the TB is used otherwise.

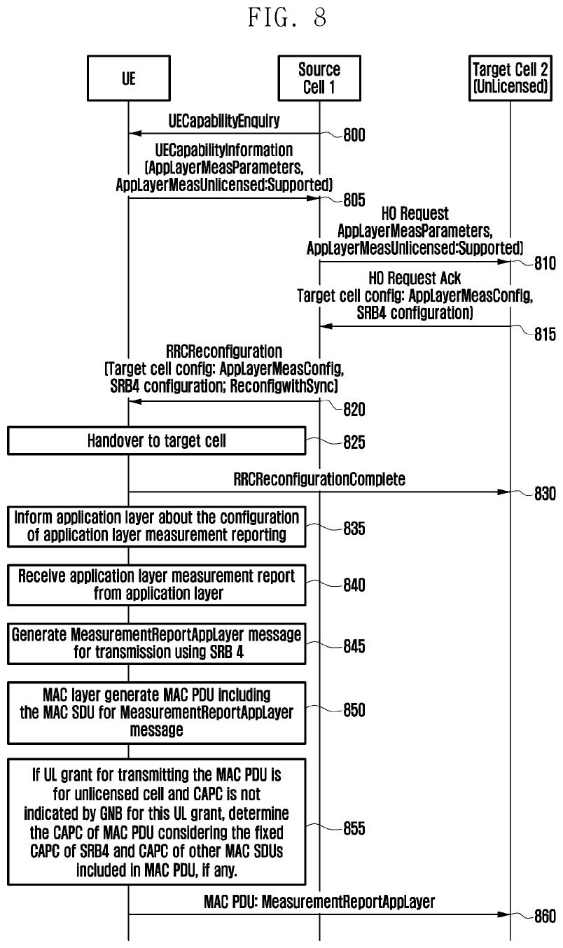

FIG. 8 illustrates a signaling flow between a UE and a gNB for application layer measurement reporting according to an embodiment of the present disclosure.

Referring to FIG. 8, a method for application layer measurement reporting in a handover scenario is illustrated, wherein the CAPC of SRB4 is fixed or predetermined. The following operations are disclosed for the sake of clarity and ease of comprehension. It should be understood that not all of these operations are essential to the disclosure, and certain operations may be selectively omitted as appropriate.

In operation 800, Cell 1 (i.e., source cell/serving cell) may send a UE in an RRC_CONNECTED state a capability enquiry message to enquire about the UE capabilities (e.g., a UE capability enquiry message may request for UE capabilities for application layer measurement reporting). In operation 805, the UE may send the UE capability information message, wherein the message includes the UE capabilities for application layer measurement reporting. The UE capabilities indicate whether the UE supports application layer measurement reporting on unlicensed spectrum.

In operation 810 Cell 1 may send the UE capabilities (including whether the UE supports application layer measurement reporting on unlicensed spectrum) for application layer measurement reporting to Cell 2 (i.e., target cell) in a handover request message over Xn interface. Here, Cell 2 may operate in unlicensed spectrum. Cell 2 may configure SRB4 and AppLayerMeasConfig to the UE. In operation 815, Cell 2 may send these configurations to Cell 1 in a handover request ack message, if the UE supports application layer measurement reporting on unlicensed spectrum. In operation 820, Cell 1 may send these configurations to the UE in an RRCReconfiguration message with reconfiguration with sync (or handover command to handover to Cell 2). In operation 825, the UE may handover to Cell 2 by performing a random access procedure. In operation 830, the UE may send the RRCReconfiguration complete message to Cell 2.

In operation 835, the UE (or RRC layer in a UE) may also inform the application layer about the configuration of application layer measurement reporting of Cell 2 received from Cell 1. In operation 840, the UE (or RRC layer in a UE) may receive the application layer measurement report from the application layer. In operation 845, the UE (or RRC layer in a UE) may generate a MeasurementReportAppLayer message for transmission using the SRB4. In operation 850, the UE (or MAC layer in a UE) may generate a MAC PDU including the MAC SDU for the MeasurementReportAppLayer message. The UE may determine to transmits the MAC PDU to Cell 2 in UL grant (configured grant or dynamic grant).

In operation 855, if UL grant for transmitting the MAC PDU is for unlicensed cell and CAPC is not indicated by a gNB for the UL grant, the UE (or MAC layer in a UE) may determine the CAPC of MAC PDU considering the fixed CAPC of SRB4 (e.g., CAPC 4 or CAPC 3 or CAPC 2 or CAPC 1) and CAPC of other MAC SDUs (i.e., CAPC of RBs of other MAC SDUs) included in MAC PDU, if any. In operation 860, the UE (or MAC layer in a UE) may transmit the MAC PDU after accessing the channel based on determined CAPC of the MAC PDU.

Determination of the CAPC of MAC PDU: The Channel Access Priority Classes (CAPC) of radio bearers and MAC CEs are either fixed or configurable:
Fixed to the lowest priority for the padding BSR and recommended bit rate MAC CEs;
Fixed to the highest priority for SRB0, SRB1, SRB3, SRB4 and other MAC CEs; and/or
Configured by the gNB for SRB2 and DRB.

When performing Type 1 LBT for the transmission of an uplink TB and when the CAPC is not indicated in the DCI, the UE may select the CAPC as follows:
If only MAC CE(s) is included in the TB, the highest priority CAPC of those MAC CE(s) is used;
If CCCH SDU(s) are included in the TB, the highest priority CAPC (i.e., CAPC 1) is used (or the highest priority CAPC of the CCCH SDU(s) is used);
If DCCH SDU(s) are included in the TB, the highest priority CAPC of the DCCH SDU(s) is used; and/or
The lowest priority CAPC of the logical channel(s) with MAC SDU multiplexed in the TB is used otherwise.

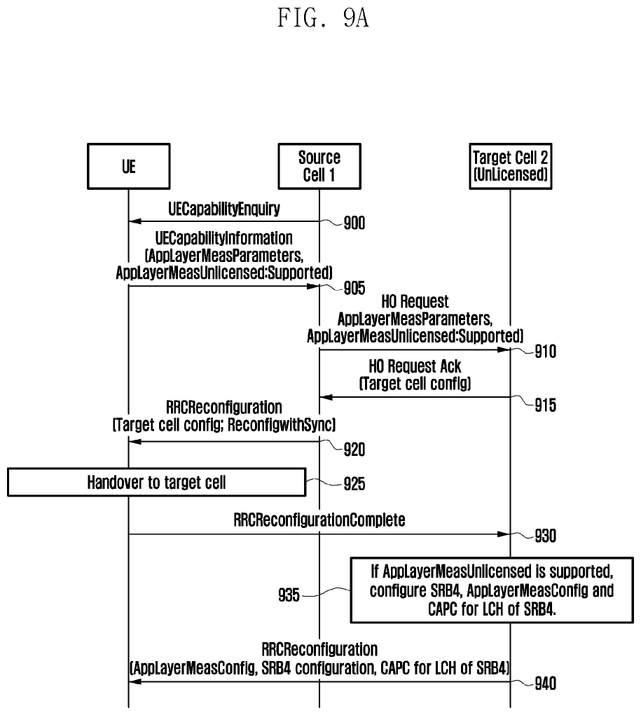

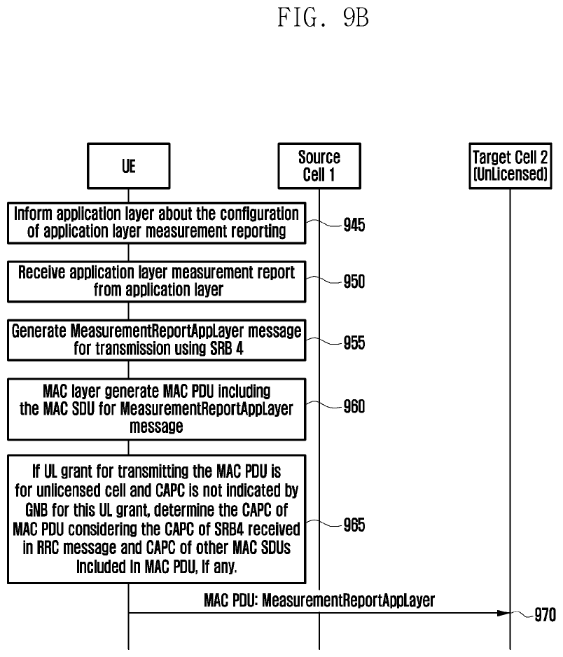

FIGS. 9A and 9B illustrate signaling flows between a UE and a gNB for application layer measurement reporting according to an embodiment of the present disclosure. Referring to FIGS. 9A and 9B, a method for application layer measurement reporting in a handover scenario is illustrated, wherein the CAPC of SRB4 is configured by an RRC reconfiguration message after completion of the handover. The following operations are disclosed for the sake of clarity and ease of comprehension. It should be understood that not all of these operations are essential to the disclosure, and certain operations may be selectively omitted as appropriate.

In operation 900, Cell 1 (i.e., source cell/serving cell) may send a UE in an RRC_CONNECTED state a capability enquiry message to enquire about the UE capabilities (e.g., a UE capability enquiry message may request for UE capabilities for application layer measurement reporting). In operation 905, the UE may send the UE capability information message, wherein the message includes the UE capabilities for application layer measurement reporting. The UE capabilities indicate whether the UE supports application layer measurement reporting on unlicensed spectrum.

In operation 910 Cell 1 may send the UE capabilities (including whether the UE supports application layer measurement reporting on unlicensed spectrum) for application layer measurement reporting to Cell 2 (i.e., target cell) in a handover request message over Xn interface. Here, Cell 2 may operate in unlicensed spectrum. In operation 915, Cell 2 mat send a target cell configuration to Cell 1 in a handover request ack message. In operation 920, Cell 1 may send the target cell configuration to the UE in an RRCReconfiguration message with reconfiguration with sync (or handover command to handover to Cell 2). In operation 925, the UE may handover to Cell 2 by performing a random access procedure. In operation 930, the UE may send the RRCReconfiguration complete message to Cell 2.

In operation 935, upon completion of the handover, if the UE supports application layer measurement reporting on unlicensed spectrum, Cell 2 may configure SRB4, AppLayerMeasConfig and CAPC of LCH of SRB4 to the UE. In operation 940, Cell 2 may send these configurations to the UE in an RRCReconfiguration message. Alternatively, if the UE does not support application layer measurement reporting on unlicensed spectrum, Cell 2 may not configure SRB4, AppLayerMeasConfig and CAPC of LCH of SRB4 to the UE, as Cell 2 is operating on unlicensed spectrum. In operation 945, the UE (or RRC layer in a UE) may also inform the application layer about the configuration of application layer measurement reporting of Cell 2 received from Cell 1. In operation 950, the UE (or RRC layer in a UE) may receive the application layer measurement report from the application layer. In operation 955, the UE (or RRC layer in a UE) may generate a MeasurementReportAppLayer message for transmission using the SRB4. In operation 960, the UE (or MAC layer in a UE) may generate a MAC PDU including the MAC SDU for the MeasurementReportAppLayer message. The UE may determine to transmits the MAC PDU to Cell 2 in UL grant (configured grant or dynamic grant).

In operation 965, if UL grant for transmitting the MAC PDU is for unlicensed cell and CAPC is not indicated by a gNB for the UL grant, the UE (or MAC layer in a UE) may determine the CAPC of MAC PDU considering the CAPC of SRB4 received in an RRC message and CAPC of other MAC SDUs (i.e., CAPC of RBs of other MAC SDUs) included in MAC PDU, if any. In operation 970, the UE (or MAC layer in a UE) may transmit the MAC PDU after accessing the channel based on determined CAPC of the MAC PDU.

Determination of the CAPC of MAC PDU: The Channel Access Priority Classes (CAPC) of radio bearers and MAC CEs are either fixed or configurable:
Fixed to the lowest priority for the padding BSR and recommended bit rate MAC CEs;
Fixed to the highest priority for SRB0, SRB1, SRB3 and other MAC CEs; and/pr
Configured by the gNB for SRB2, SRB4 and DRB.

When performing Type 1 LBT for the transmission of an uplink TB and when the CAPC is not indicated in the DCI, the UE may select the CAPC as follows:
If only MAC CE(s) is included in the TB, the highest priority CAPC of those MAC CE(s) is used;
If CCCH SDU(s) are included in the TB, the highest priority CAPC (i.e., CAPC 1) is used (or the highest priority CAPC of the CCCH SDU(s) is used);
If DCCH SDU(s) are included in the TB, the highest priority CAPC of the DCCH SDU(s) is used; and/or
The lowest priority CAPC of the logical channel(s) with MAC SDU multiplexed in the TB is used otherwise.

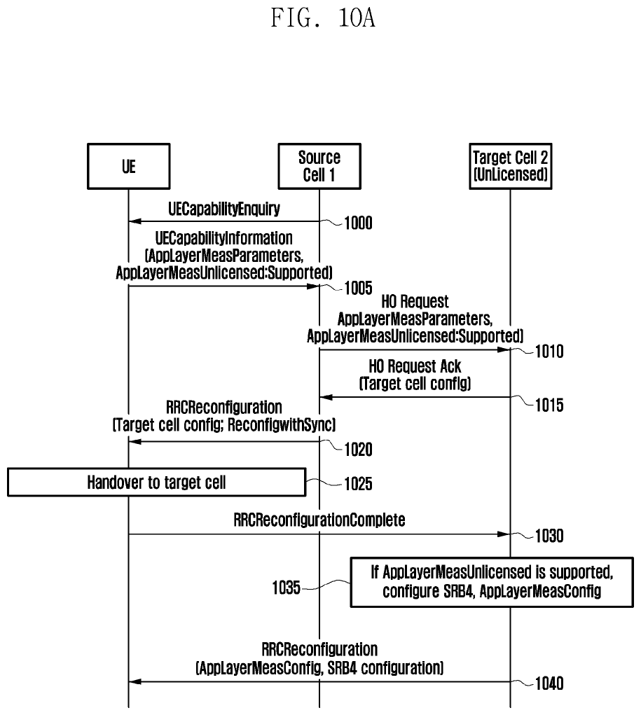

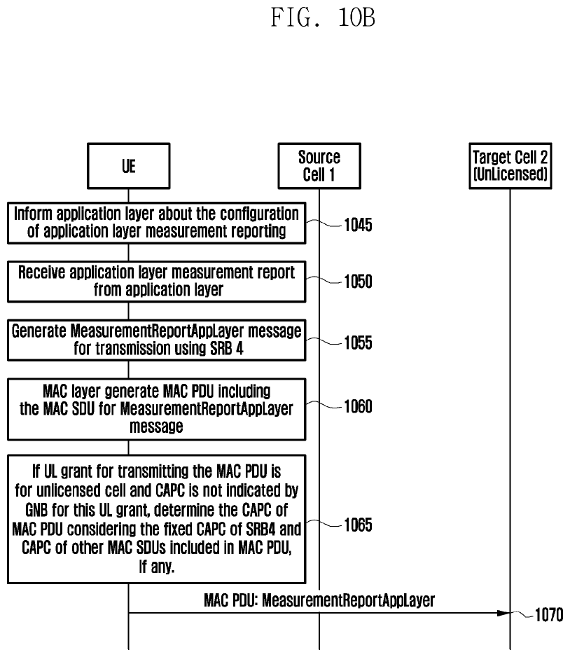

FIGS. 10A and 10B illustrate signaling flows between a UE and a gNB for application layer measurement reporting according to an embodiment of the disclosure. Referring to FIGS. 10A and 10B, a method for application layer measurement reporting in a handover scenario is illustrated, wherein SRB4 and AppLayerMeasConfig are configured by an RRC reconfiguration message after completion of the handover but the CAPC of SRB4 is fixed or predetermined. The following operations are disclosed for the sake of clarity and ease of comprehension. It should be understood that not all of these operations are essential to the disclosure, and certain operations may be selectively omitted as appropriate.

In operation 1000, Cell 1 (i.e., source cell/serving cell) may send a UE in an RRC_CONNECTED state a capability enquiry message to enquire about the UE capabilities (e.g., a UE capability enquiry message may request for UE capabilities for application layer measurement reporting). In operation 1005, the UE may send the UE capability information message, wherein the message includes the UE capabilities for application layer measurement reporting. The UE capabilities indicate whether the UE supports application layer measurement reporting on unlicensed spectrum.

In operation 1010 Cell 1 may send the UE capabilities (including whether the UE supports application layer measurement reporting on unlicensed spectrum) for application layer measurement reporting to Cell 2 (i.e., target cell) in a handover request message over Xn interface. Here, Cell 2 may operate in unlicensed spectrum. In operation 1015, Cell 2 mat send a target cell configuration to Cell 1 in a handover request ack message. In operation 1020, Cell 1 may send the target cell configuration to the UE in an RRCReconfiguration message with reconfiguration with sync (or handover command to handover to Cell 2). In operation 1025, the UE may handover to Cell 2 by performing a random access procedure. In operation 1030, the UE may send the RRCReconfiguration complete message to Cell 2.

In operation 1035, upon completion of the handover, if the UE supports application layer measurement reporting on unlicensed spectrum, Cell 2 may configure SRB4 and AppLayerMeasConfig to the UE. In operation 1040, Cell 2 may send these configurations to the UE in an RRCReconfiguration message. Alternatively, if the UE does not support application layer measurement reporting on unlicensed spectrum, Cell 2 may not configure SRB4 and AppLayerMeasConfig to the UE, as Cell 2 is operating on unlicensed spectrum. In operation 1045, the UE (or RRC layer in a UE) may also inform the application layer about the configuration of application layer measurement reporting of Cell 2 received from Cell 1. In operation 1050, the UE (or RRC layer in a UE) may receive the application layer measurement report from the application layer. In operation 1055, the UE (or RRC layer in a UE) may generate a MeasurementReportAppLayer message for transmission using the SRB4. In operation 1060, the UE (or MAC layer in a UE) may generate a MAC PDU including the MAC SDU for the MeasurementReportAppLayer message. The UE may determine to transmits the MAC PDU to Cell 2 in UL grant (configured grant or dynamic grant).

In operation 1065, if UL grant for transmitting the MAC PDU is for unlicensed cell and CAPC is not indicated by a gNB for the UL grant, the UE (or MAC layer in a UE) may determine the CAPC of MAC PDU considering the fixed CAPC of SRB4 (e.g., CAPC 4 or CAPC 3 or CAPC 2 or CAPC 1) and CAPC of other MAC SDUs (i.e., CAPC of RBs of other MAC SDUs) included in MAC PDU, if any. In operation 1070, the UE (or MAC layer in a UE) may transmit the MAC PDU after accessing the channel based on determined CAPC of the MAC PDU.

Determination of the CAPC of MAC PDU: The Channel Access Priority Classes (CAPC) of radio bearers and MAC CEs are either fixed or configurable:
Fixed to the lowest priority for the padding BSR and recommended bit rate MAC CEs;
Fixed to the highest priority for SRB0, SRB1, SRB3, SRB4 and other MAC CEs; and/or
Configured by the gNB for SRB2 and DRB.

When performing Type 1 LBT for the transmission of an uplink TB and when the CAPC is not indicated in the DCI, the UE may select the CAPC as follows:
If only MAC CE(s) is included in the TB, the highest priority CAPC of those MAC CE(s) is used;
If CCCH SDU(s) are included in the TB, the highest priority CAPC (i.e., CAPC 1) is used (or the highest priority CAPC of the CCCH SDU(s) is used);
If DCCH SDU(s) are included in the TB, the highest priority CAPC of the DCCH SDU(s) is used; and/or
The lowest priority CAPC of the logical channel(s) with MAC SDU multiplexed in the TB is used otherwise.

In various embodiments of the disclosure, if the UE is in an RRC_IDLE state, the UE may include an indication of whether the UE supports application layer measurement reporting on unlicensed spectrum in RRCSetupRequest or RRCSetupComplete during the connection setup procedure. Based on this indication, if the UE supports application layer measurement reporting on unlicensed spectrum, and a cell with which the UE is establishing connection is unlicensed cell, the cell may configure SRB4 and AppLayerMeasConfig to the UE and send these configurations to the UE in an RRCSetup or an RRCReconfiguration message. Here, the CAPC of LCH of SRB4 may be fixed. Alternately, based on this indication, if the UE supports application layer measurement reporting on unlicensed spectrum, and a cell with which the UE is establishing connection is unlicensed cell, the cell may configure SRB4, AppLayerMeasConfig and CAPC of LCH of SRB4 to the UE and send these configuration to the UE in an RRCSetup or an RRCReconfiguration message.

In various embodiments of the disclosure, the CAPC of LCH of SRB4 may be configured by a gNB in system information instead of dedicated RRC message and the same is used to determine the CAPC of MAC PDU including application layer measurement report.

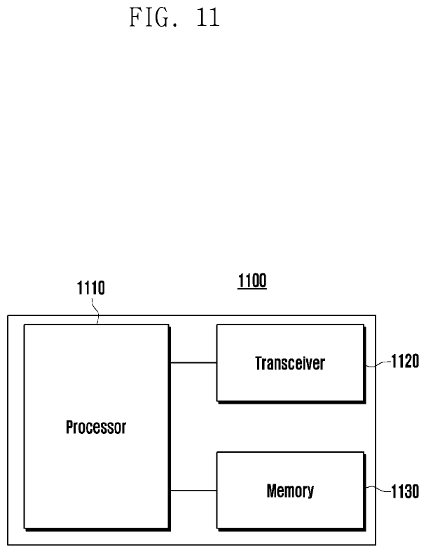

FIG. 11 illustrates an electronic device according to embodiments of the present disclosure.

Referring to the FIG. 11, the electronic device 1100 may include a processor 1110, a transceiver 1120 and a memory 1130. However, all of the illustrated components are not essential. The electronic device 1100 may be implemented by more or less components than those illustrated in FIG. 11. In addition, the processor 1110 and the transceiver 1120 and the memory 1130 may be implemented as a single chip according to another embodiment.

The electronic device 1100 may correspond to the UE described above. The aforementioned components will now be described in detail.

The processor 1110 may include one or more processors or other processing devices that control the provided function, process, and/or method. Operation of the electronic device 1100 may be implemented by the processor 1110.

The transceiver 1120 may include a RF transmitter for up-converting and amplifying a transmitted signal, and a RF receiver for down-converting a frequency of a received signal. However, according to another embodiment, the transceiver 1120 may be implemented by more or less components than those illustrated in components.

The transceiver 1120 may be connected to the processor 1110 and transmit and/or receive a signal. The signal may include control information and data. In addition, the transceiver 1120 may receive the signal through a wireless channel and output the signal to the processor 1110. The transceiver 1120 may transmit a signal output from the processor 1110 through the wireless channel.

The memory 1130 may store the control information or the data included in a signal obtained by the electronic device 1100. The memory 1130 may be connected to the processor 1110 and store at least one instruction or a protocol or a parameter for the provided function, process, and/or method. The memory 1130 may include read-only memory (ROM) and/or random access memory (RAM) and/or hard disk and/or CD-ROM and/or DVD and/or other storage devices.

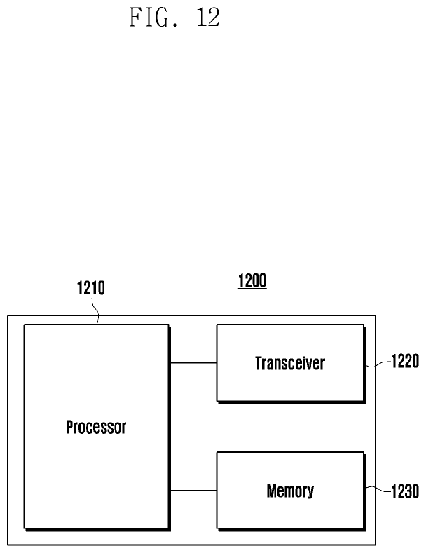

FIG. 12 illustrates a base station according to embodiments of the present disclosure.

Referring to the FIG. 12, the base station 1200 may include a processor 1210, a transceiver 1220 and a memory 1230. However, all of the illustrated components are not essential. The base station 1200 may be implemented by more or less components than those illustrated in FIG. 12. In addition, the processor 1210 and the transceiver 1220 and the memory 1230 may be implemented as a single chip according to another embodiment.

The base station 1200 may correspond to the gNB described above.

The aforementioned components will now be described in detail.

The processor 1210 may include one or more processors or other processing devices that control the provided function, process, and/or method. Operation of the base station 1200 may be implemented by the processor 1210.

The transceiver 1220 may include a RF transmitter for up-converting and amplifying a transmitted signal, and a RF receiver for down-converting a frequency of a received signal. However, according to another embodiment, the transceiver 1220 may be implemented by more or less components than those illustrated in components.

The transceiver 1220 may be connected to the processor 1210 and transmit and/or receive a signal. The signal may include control information and data. In addition, the transceiver 1220 may receive the signal through a wireless channel and output the signal to the processor 1210. The transceiver 1220 may transmit a signal output from the processor 1210 through the wireless channel.

The memory 1230 may store the control information or the data included in a signal obtained by the base station 1200. The memory 1230 may be connected to the processor 1210 and store at least one instruction or a protocol or a parameter for the provided function, process, and/or method. The memory 1230 may include read-only memory (ROM) and/or random access memory (RAM) and/or hard disk and/or CD-ROM and/or DVD and/or other storage devices.

While the disclosure has been shown and described with reference to various embodiments thereof, it will be understood by those skilled in the art that various changes in form and details may be made therein without departing from the spirit and scope of the disclosure as defined by the appended claims and their equivalents.

As described above, embodiments disclosed in the specification and drawings are merely used to present specific examples to easily explain the contents of the disclosure and to help understanding, but are not intended to limit the scope of the disclosure. Accordingly, the scope of the disclosure should be analyzed to include all changes or modifications derived based on the technical concept of the disclosure in addition to the embodiments disclosed herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
receiving, from a base station, configuration information for an application layer measurement reporting;
generating, based on the configuration information, a medium access control (MAC) protocol data unit (PDU) including a MAC service data unit (SDU) for an application layer measurement report message;
in case that an uplink (UL) grant for the MAC PDU is associated with a shared spectrum, determining a channel access priority class (CAPC) of the MAC PDU based on a CAPC for a logical channel (LCH) of signaling radio bearer 4 (SRB4); and
transmitting, to the base station, the MAC PDU after a channel access procedure based on the CAPC of the MAC PDU.

2. The method of claim 1, wherein the CAPC for the LCH of SRB4 is configured by a radio resource control (RRC) message.

3. The method of claim 1, wherein the CAPC for the LCH of SRB4 is predetermined.

4. The method of claim 1, wherein determining the CAPC of the MAC PDU further comprises:
determining the CAPC of the MAC PDU based on the CAPC for the LCH of SRB4 and one or more CAPCs of one or more other MAC SDUs included in the MAC PDU.

5. The method of claim 1, further comprising:
receiving, from the base station, a UE capability enquiry message requesting capabilities for the application layer measurement reporting; and
transmitting, to the base station, a UE capability information message indicating that the UE is capable of supporting the application layer measurement reporting on the shared spectrum.

6. A method performed by a base station in a wireless communication system, the method comprising:
transmitting, to a user equipment (UE), configuration information for an application layer measurement reporting; and
receiving, from the UE, a medium access control (MAC) protocol data unit (PDU) including a MAC service data unit (SDU) for an application layer measurement report message generated based on the configuration information,
wherein in case that an uplink (UL) grant for the MAC PDU is associated with a shared spectrum, a channel access priority class (CAPC) of the MAC PDU is associated with a CAPC for a logical channel (LCH) of signaling radio bearer 4 (SRB4).

7. The method of claim 6, wherein the CAPC for the LCH of SRB4 is configured by a radio resource control (RRC) message.

8. The method of claim 6, wherein the CAPC for the LCH of SRB4 is predetermined.

9. The method of claim 6, wherein the CAPC of the MAC PDU is associated with the CAPC for the LCH of SRB4 and one or more CAPCs of one or more other MAC SDUs included in the MAC PDU.

10. The method of claim 6, further comprising:
transmitting, to the UE, a UE capability enquiry message requesting capabilities for the application layer measurement reporting; and
receiving, from the UE, a UE capability information message indicating that the UE is capable of supporting the application layer measurement reporting on the shared spectrum.

11. A user equipment (UE) in a wireless communication system, the UE comprising:
a transceiver; and
a controller operably coupled to the transceiver, the controller configured to:
receive, from a base station via the transceiver, configuration information for an application layer measurement reporting,
generate, based on the configuration information, a medium access control (MAC) protocol data unit (PDU) including a MAC service data unit (SDU) for an application layer measurement report message,
in case that an uplink (UL) grant for the MAC PDU is associated with a shared spectrum, determine a channel access priority class (CAPC) of the MAC PDU based on a CAPC for a logical channel (LCH) of signaling radio bearer 4 (SRB4), and
transmit, to the base station via the transceiver, the MAC PDU after a channel access procedure based on the CAPC of the MAC PDU.

12. The UE of claim 11, wherein the CAPC for the LCH of SRB4 is configured by a radio resource control (RRC) message.

13. The UE of claim 11, wherein the CAPC for the LCH of SRB4 is predetermined.

14. The UE of claim 11, wherein the controller is further configured to:
determine the CAPC of the MAC PDU based on the CAPC for the LCH of SRB4 and one or more CAPCs of one or more other MAC SDUs included in the MAC PDU.

15. The UE of claim 11, wherein the controller is further configured to:
receive, from the base station via the transceiver, a UE capability enquiry message requesting capabilities for the application layer measurement reporting; and
transmit, to the base station via the transceiver, a UE capability information message indicating that the UE is capable of supporting the application layer measurement reporting on the shared spectrum.

16. A base station in a wireless communication system, the base station comprising:
a transceiver; and
a controller operably coupled to the transceiver, the controller configured to:
transmit, to a user equipment (UE) via the transceiver, configuration information for an application layer measurement reporting, and
receive, from the UE via the transceiver, a medium access control (MAC) protocol data unit (PDU) including a MAC service data unit (SDU) for an application layer measurement report message generated based on the configuration information,
wherein in case that an uplink (UL) grant for the MAC PDU is associated with a shared spectrum, a channel access priority class (CAPC) of the MAC PDU is associated with a CAPC for a logical channel (LCH) of signaling radio bearer 4 (SRB4).

17. The base station of claim 16, wherein the CAPC for the LCH of SRB4 is configured by a radio resource control (RRC) message.

18. The base station of claim 16, wherein the CAPC for the LCH of SRB4 is predetermined.

19. The base station of claim 16, wherein the CAPC of the MAC PDU is associated with the CAPC for the LCH of SRB4 and one or more CAPCs of one or more other MAC SDUs included in the MAC PDU.

20. The base station of claim 16, wherein the controller is further configured to:
transmit, to the UE via the transceiver, a UE capability enquiry message requesting capabilities for the application layer measurement reporting; and
receive, from the UE via the transceiver, a UE capability information message indicating that the UE is capable of supporting the application layer measurement reporting on the shared spectrum.
